(19) United States
(12) Patent Application Publication
(10) Pub. No.: US 2026/0105532 A1
(43) Pub. Date: Apr. 16, 2026

(54) ALTERNATIVE DEDUCTIBLE

(71) Applicant: ALLSTATE INSURANCE COMPANY, NORTHBROOK, IL (US)

(72) Inventors: Michael S. Watson, Delaware, OH (US); Surender Gupta, Chicago, IL (US); Thomas J. Wilson, Chicago, IL (US)

(21) Appl. No.: 19/333,890

(22) Filed: Sep. 19, 2025

Related U.S. Application Data
(60) Provisional application No. 63/705,760, filed on Oct. 10, 2024.

(51) Int. Cl. G06Q 40/08

(52) U.S. Cl. CPC G06Q 40/0842

(57) ABSTRACT

Methods, computer-readable media, software, and apparatuses provide a system for adjusting a deductible and/or determining eligibility for a deductible payment plan based on a user situation, wherein the user situation may include a driving situation and/or a home situation. Information regarding the user situation related to a vehicle or a home may be obtained from various sources. The information may be used to evaluate a degree of safety of the user situation. For example, the degree of safety may be associated with a user operating a vehicle and/or maintaining a home over a period of time. Based on the degree of safety of the user situation, the adjustment of the deductible and/or eligibility for the deductible payment plan may be determined. The system may also utilize one or more algorithms to process the information to determine eligibility for a deductible payment plan and/or adjustment of the deductible.

### CROSS-REFERENCE TO RELATED APPLICATIONS

This claims priority to U.S. Provisional Patent Application No. 63/705,760, filed on Oct. 10, 2024, the entire contents of which are incorporated by reference herein.

### FIELD OF ART

Aspects of the disclosure generally relate to methods and computer systems, including one or more computers particularly configured and/or executing computer software. More particularly, aspects of this disclosure relate to a system for determining an insurance deductible based on sensor data.

### BACKGROUND

Insurance policies, such as automotive or home insurance policies, typically specify, among other things, a premium and a deductible. The premium is an amount of money a policy holder pays on a regular basis (e.g., monthly) to maintain the insurance policy. The deductible is the amount of money a policy holder is responsible for paying for any given claim before an insurance company takes responsibility to cover the remaining amount of the claim. Premiums and deductibles may be different for different policy holders and different insurance companies may offer the same person different premiums and deductibles. Premiums and deductibles may be determined by a variety of factors, including demographic information and geographic information. Premiums and deductibles may also be based on a policy holder's past claims. For example, a policy holder who has submitted numerous insurance claims may have a higher premium and/or deductible than a policy holder who has not made any insurance claims.

In some cases, a premium and deductible for a specific policy holder may change over time. For example, the premium and deductible for a specific policy holder may rise because of inflation, a cost in automotive repairs, or a cost in home repairs. In contrast, the premium and deductible for a specific policy holder may fall because the policy holder has maintained a safe driving record over some period of time (e.g., has not been involved in an accident for five years). In other cases, the premium and deductible for a specific policy holder may rise or fall based on a usage-based insurance policy such as a pay as your drive, pay how you drive, and/or a mile-based insurance policy. Still, in other cases, the premium and deductible for a specific policy holder may fall because the policy holder has maintained a safe home record over some period of time. For example, knowing that their driving record may affect their premiums and deductibles, some policy holders may alter their driving behavior to avoid automotive accidents. However, some policy holders doubt that changing their driving behavior will reduce the likelihood of being in an automotive accident and some policy holders doubt that they will ever receive a decrease in their insurance premium and/or deductible even if they are not involved in an accident. Thus, promises to reduce premiums and deductibles of those who avoid accidents will not persuade some policy holders to improve their driving behavior.

Generally, insurance companies, like most companies, are interested in keeping costs down. For insurance companies, costs may be incurred when customers are involved in accidents. Therefore, insurance companies may be interested in reducing the likelihood of automotive accidents. As such, an insurance company may be interested in incentivizing its customers (e.g., policy holders) to drive safely.

Accordingly, new systems, devices, methodologies, and software are desired to adjust insurance deductibles on-the-fly while policy holders are driving to incentivize them to drive safely.

### BRIEF SUMMARY

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents some concepts of the invention in a simplified form as a prelude to the more detailed description provided below.

Aspects of the disclosure address one or more of the issues mentioned above by disclosing methods, computer readable storage media, software, systems, and apparatuses for providing a deductible determination system that may determine and/or adjust a deductible of an insurance policy while a policy holder is driving. The system allows an insurance deductible to be modified or adjusted on the fly in accordance with a current driving situation. The deductible may be based on various factors, such as current external conditions, current internal conditions, a current condition of the driver, a current condition of the vehicle. The system also provides the adjusted deductible to the driver while she is driving so as to incentive her to drive safely or take other measures to avoid an accident. The value provided to the driver may correspond to an amount of the adjustment (e.g., an amount of an increase or decrease) or the newly determined deductible (e.g., the full deductible that is in effect).

Aspects of the disclosure disclose methods, computer readable storage media, software, systems, and apparatuses for providing a deductible determination system that may determine eligibility for a deductible payment plan. The system may allow a user to spread out the deductible payments over a predetermined length of time rather than paying the deductible up front at the time of an accident. The system may determine eligibility for the deductible payment plan based on various factors, such as driving history, driving record, number of accidents, a degree of safety while driving, a degree of safety while maintain a home, a current condition of the driver, and/or financial information associated with a user such as monetary assets. The system may utilize a driving safety score and/or a financial profile to determine eligibility for the deductible payment plan. The system may utilize sensor data and/or financial data to determine eligibility for the deductible payment plan. The system may allow users to enroll into the deductible payment plan with a computing device connected to the system.

Aspects of this disclosure provide a system comprising an end user computing device (e.g., a mobile computing device, such as a cell phone, tablet, personal digital assistant, etc., desktop or laptop computer, or vehicle computing device, such as a device installed in a vehicle dashboard) associated with a vehicle and a network computing device (e.g., a server). The end user device may include a network interface configured to communicate over a wired or wireless network. Meanwhile, the network computing device may include a network interface configured to exchange communications with the end user computing device. The network computing device may be configured to obtain, from the end user computing device or another network computing device (e.g., a third party server), driving situation information indicating a driving situation related to the vehicle while the vehicle is moving (e.g., a current driving situation at a point in time during a trip). For example, the driving situation information may include weather information regarding weather at a location of the vehicle, traffic information regarding traffic at the location of the vehicle, road information regarding a condition or level of safety of a road on which the vehicle travels, vehicle status information regarding a condition of the vehicle, vehicle condition information regarding a condition inside or in proximity to the vehicle, driving behavior information regarding a speed, acceleration, or deceleration of the vehicle, driver status information regarding a condition of a driver of the vehicle, or driver choice information regarding whether the driver of the vehicle chose to block a text message or phone call.

The network computing device may also be configured to determine a degree of safety of the driving situation based on at least a portion of the driving situation information. In some embodiments, the network computing device may also be configured to determine a degree of safety of the home situation based on at least a portion of the home situation information. Determining the degree of safety of the driving situation and/or home situation may include determining a safety score. In some embodiments, determining the degree of safety of the driving situation and/or home situation based on at least the portion of the driving situation information and/or the home situation information may include determining a value based on at least the portion of the driving situation information and/or home situation information, and determining a safety score by computing an algorithm using the value. Also, the network computing device may be further configured to select the algorithm from a plurality of algorithms, and determine a weight to be assigned to the value.

The network computing device may be further configured to obtain a deductible of an insurance policy for the vehicle or home, and adjust the deductible based on the degree of safety of the user situation. The user situation may comprise one or more of a driving situation and/or a home situation. In some embodiments, the network computing device may be further configured to determine eligibility for a deductible payment plan for a deductible based on the degree of safety of the user situation. Adjusting the deductible based on the degree of safety of the driving situation and/or home situation may include using data regarding past accidents or past insurance claims on a vehicle or a home. Determining eligibility for the deductible payment plan based on the degree of safety of the user situation may include using data regarding past accidents or past insurance claims on the vehicle or the home. In some embodiments, adjusting the deductible using the data regarding past accidents or past insurance claims may include decreasing the deductible when a number of past accidents on a route along which the vehicle is moving is below a first threshold or increasing the deductible when the number of past accidents on the route is above a second threshold. The first and second thresholds may be the same or different.

Further, adjusting the deductible based on the degree of safety of the driving situation may include decreasing the deductible in response to an increase in the degree of safety of the driving situation or increasing the deductible in response to a decrease in the degree of safety of the driving situation.

Aspects of the disclosure also provide the computing devices of the system as well as the computer readable media of those computing devices that store deductible determination programs. Specifically, aspects of the disclosure provide a computing device, including a network interface configured to communicate with a server or an end user computing device while the end user computing device is traveling within a vehicle. The computing device may also include at least one processor. The at least one processor may be configured to execute computer-executable instructions (e.g., a deductible determination program) stored on computer readable media (including non-transitory computer readable media). The at least one processor may also be configured to cause (or control) the computing device to obtain, from the end user computing device or the server, driving situation information indicating a driving situation related to the vehicle while the vehicle is on a trip; determine a degree of safety of the driving situation based on at least a portion of the driving situation information; obtain a deductible of an insurance policy for the vehicle; and determine an amount by which to adjust the deductible based on the degree of safety of the driving situation. The at least one processor may be configured to further cause the computing device to store the adjusted deductible in memory. Also, the at least one processor may be configured to further cause the computing device to store, in memory, a time at which the amount is determined. Moreover, the at least one processor may be configured to further cause the computing device to transmit, to the end user computing device, a notification indicating the amount by which the deductible is adjusted.

Aspects of the disclosure further provide a method of determining an adjustment to a deductible. The method may include receiving, by a computing device (e.g., a mobile phone) from a sensor (e.g., light sensor, tire pressure sensor, weather balloon sensor, etc.) in proximity to a vehicle, driving situation information indicating a driving situation related to the vehicle while the vehicle is traveling along a route; determining a degree of safety of the driving situation based at least on the driving situation information; obtaining a deductible of an insurance policy for the vehicle; and determining an adjustment to the deductible based on the degree of safety of the driving situation. Determining the adjustment to the deductible based on the degree of safety of the driving situation may include determining the degree of safety of driving on the route based on past accident information or past insurance claim information. The method may also include outputting, via a display of the computing device or a speaker of the computing device, a notification to a driver of the vehicle, the notification indicating the adjustment to the deductible. Further, the method may include transmitting, by the computing device to an insurance company's server, the adjustment to the deductible and a time at which the adjustment to the deductible was determined.

Aspects of the disclosure further provide a method and/or a system for determining eligibility for a deductible payment plan or deductible spreading offer. The system may allow a user to spread out the deductible payments over a predetermined length of time rather than paying the deductible up front. The system may include receiving, by a computing device (e.g., mobile device, connected home device) from a sensor (e.g., smoke detector, tire pressure sensor, thermostat, etc.) in proximity of a home or a vehicle. The system may determine eligibility for the deductible payment plan based on various factors, such as sensor data and/or financial data. For example, the system may utilize sensor data from a home and a recent home loan represented in the financial data to determine a user may be eligible for enrollment into the deductible payment plan. For example, the system may utilize sensor data from a vehicle and a recent auto loan represented in the financial data to determine a user may be eligible for enrollment into the deductible payment plan. The system may allow a user to enroll into the deductible payment plan with a computing device connected to the system.

Of course, the methods and systems of the above-referenced embodiments may also include other additional elements, steps, computer-executable instructions, or computer-readable data structures. In this regard, other embodiments are disclosed and claimed herein as well. The details of these and other embodiments of the present invention are set forth in the accompanying drawings and the description below. Other features and advantages of the invention will be apparent from the description, drawings, and claims.

### BRIEF DESCRIPTION OF THE DRAWINGS

The present invention is illustrated by way of example and is not limited by the accompanying figures in which like reference numerals indicate similar elements and in which:

FIG. 1 is a block diagram of an example computing device that may be used according to an illustrative embodiment of the present disclosure.

FIG. 2 illustrates an example network environment in which a system in accordance with the present disclosure may be implemented.

FIG. 3 illustrates a flow diagram of an example process in accordance with aspects of the present disclosure.

FIGS. 4-6 illustrate example interfaces that may be presented by computing devices configured according to aspects of the present disclosure.

FIGS. 7 and 8 illustrate a flow diagram of an example process in accordance with aspects of the present disclosure.

FIG. 9 illustrates a flow diagram of an example process in accordance with aspects of the present disclosure.

FIG. 10 illustrates a flow diagram of an example process in accordance with aspects of the present disclosure.

### DETAILED DESCRIPTION

In accordance with various aspects of the disclosure, methods, computer-readable media, software, and apparatuses disclose a deductible determination system (or system) for determining a deductible payment plan or deductible spreading offer based on sensor data and/or financial data associated with a user. The user may obtain an insurance policy including a premium and a deductible for a property (e.g., home or vehicle) to help mitigate repair costs in an event of an accident. An accident can happen unexpectedly and may be a difficult problem to solve for the user. In an event of an accident (e.g., home or auto accident), the user may enroll into a deductible payment plan to spread out deductible payments over a period of time (e.g., monthly payments) to reduce the user's concerns with addressing the accident.

Eligibility for the deductible payment plan may be determined based on factors, such as sensor data in proximity to a home or a vehicle, and/or financial data indicating a user's financial situation (e.g., credit report, indication of a home or auto loan). In some embodiments, eligibility for the deductible payment plan may be determined based on sensor data from a home, a vehicle, or in proximity to the home or the vehicle. For example, the system may receive sensor data from various computing devices located within the home (e.g., connected home devices, smart home appliances, smart water devices, smart electric devices, smart protection devices) or computing devices proximate the home. For example, the system may receive sensor data from one or more computing devices integrated or proximate a vehicle (e.g., mobile device located in the vehicle or on-board vehicle computing device). For example, the sensor data may indicate vehicle telematics data, vehicle ownership, home ownership, vehicle mileage, vehicle condition, home condition, characteristics of the property, or conditions of the property. For example, based on the financial data, the system may determine a financial profile for the user which may include one or more attributes such as credit history, Fair Issac Corporation (“FICO”) score, history of making on time loan payments, history of paying off loans early, history of payment options for bills such as autopay or non-autopay, monetary assets (e.g., bank accounts, type of bank accounts, number of bank accounts), and/or any combination thereof. For example, eligibility for the deductible payment plan may be based on available sensor data indicating the existence of the property and the financial profile.

In some embodiments, the deductible determination system may determine deductibles based on current driving conditions. The deductible determination system may incentivize policy holders to exhibit good driving behavior. Additionally, or alternatively, the deductible determination system may incentivize policy holders to take other measures (e.g., change routes, use a different vehicle, switch drivers, etc.) to avoid accidents or reduce a likelihood of an accident occurring or amount of damage incurred in the event of an accident. The deductible increases or decreases based on the safety of a current driving situation (e.g., a situation in which a user is driving at a time when a user is driving). The deductible can be determined based on factors, such as a driver's safety factors and historic driving score or record, current weather, current traffic, type of road, route selected for a trip, etc. In some examples, calculation of the deductible may also factor in the driver's current condition (e.g., sleepy, intoxicated, sick, etc.) and the driver's choices (e.g., choice to allow text messages to be received during the trip, choice to allow phone calls to be received during the trip, etc.).

In some embodiments, the deductible determination system may determine a payment plan for the deductible based on a user's driving record and/or financial information. The deductible determination system may allow users to spread out the deductible over a length of time (e.g., monthly payments) rather than paying the deductible up front. The eligibility for the deductible payment plan may be determined based on factors, such as a user's safety score and/or a financial profile. The user's safety score may include factors such as number of accidents, sudden brake occurrences, swerving incidents, device usage during driving, record of maintain a safe home over a period of time, number of insurance claims for a home, number of accidents of the home. The financial profile may include one or more attributes (or factors) such as credit history, FICO score, history of making on time loan payments, history of paying off loans early, and/or monetary assets such as bank or retirement accounts. In some examples, eligibility for the deductible payment plan may factor a degree of safety when driving or maintaining a home, and/or a comparison of a user's monetary assets to a monetary threshold (e.g., monetary value of the deductible).

In some embodiments, the deductible may be determined at a start of the trip. The proposed deductible may be displayed or otherwise output to a policy holder, driver, etc. prior to the start of a trip. The deductible determination system may also display different options along with an amount of the deductible for the different options. These options can include different routes, driving at a different time, using a different driver (e.g., a spouse or another employee) and other factors.

In some embodiments, the deductible determination system may determine an amount of the deductible or an amount by which a base deductible is to be adjusted (either increased or decreased). Further, in some embodiments, the deductible determination system may determine a user's eligibility for a deductible payment plan. The determination for a particular trip may be made using, for example, past insurance information (e.g., past accidents and past claim information) associated with a route of the particular trip, a type of driver of the particular trip, and driving conditions during the trip. For example, information that a large number of accidents occurred in the past along the same route currently being taken may be used to determine an increase in the deductible. Or, for example, information that a low number of accidents have occurred on the current route at the time that the current trip is being taken may be used to determine a reduction in the deductible. Accordingly, access to insurance related information in one or more databases of one or more insurance companies may be leveraged by such insurance companies to implement the deductible determination system. Further, access to financial information associated with a user in one or more databases of one or more financial institutions may be leveraged by such insurance companies to implement the deductible determination system.

In some examples, deductibles may be determined on-the-fly based on real-time data, sensor data, and/or historical data. For example, one minute a current driving situation may be deemed risky and therefore the deductible may be increased, and the next minute the current driving situation may be deemed safe and therefore the deductible may be decreased. Here, a minute interval is used as an example. Other time periods (greater or less than a minute) may be used to dictate the frequency at which a driving situation is evaluated. The deductible determinations may be made at consistent intervals or varying times (e.g., random times). In some embodiments, for example, the deductible determinations may be triggered by one or more trigger events, such as a weather alert, temperature change in a home, detecting of smoke in a home, exceeding a certain speed, braking too hard, etc.

Various algorithms may be used to determine deductible adjustments. Different algorithms may be used in different circumstances. In some embodiments, various algorithms may be used to determine an eligibility for a deductible payment plan. One algorithm may be used for one user whereas another algorithm may be used for another user. Which algorithm to use may depend on the insurance policy of the user or other information about the user, sensor data indicating property ownership, home, vehicle, driving conditions, or financial data.

In some embodiments, an amount of the adjustment of the deductible may be different for different users. For example, premium customers (e.g., policy holders with multiple insurance policies with the same insurance company) may receive greater reductions in their deductibles than other customers. As an example, a first customer having two insurance policies with an insurance company may receive a greater reduction in her deductible than a second customer having only one insurance policy with the insurance company even where the first and second customers are driving in the same or similar driving conditions and have the same or similar driving history. Accordingly, the deductible determination system may encourage some customers to purchase additional insurance policies, including non-automotive insurance, from an insurance company.

In some embodiments, different users may receive different deductible adjustments for the same behavior because of their driving history. For example, in one embodiment, a first user with a bad driving record may receive a small decrease in comparison to a second user with a good driving record even where the first and second users are driving in the same or similar driving conditions. In another embodiment, the first user with the bad driving record may receive a greater decrease in comparison to the second user with the good driving record so as to provide a stronger incentive to the first user with the bad driving record to drive more safely or in safer conditions.

As a result of aspects described herein, insurance deductibles may be adjusted on-the-fly and users may be eligible for deductible payment plans to spread out the deductible payments over a period of time. Aspects of this disclosure may lead to a reduction in automotive accidents (e.g., traffic accidents), which may lead to a reduction in costs of insurance companies, which in turn may translate into lower rates for customers of insurance companies. Aspects of this disclosure may lead to a reduction in home accidents, which may lead to a reduction in costs of insurance companies, which in turn may translate into lower rates for customers of insurance companies.

In the following description of the various embodiments of the disclosure, reference is made to the accompanying drawings, which form a part hereof, and in which is shown by way of illustration, various embodiments in which the disclosure may be practiced. It is to be understood that other embodiments may be utilized and structural and functional modifications may be made.

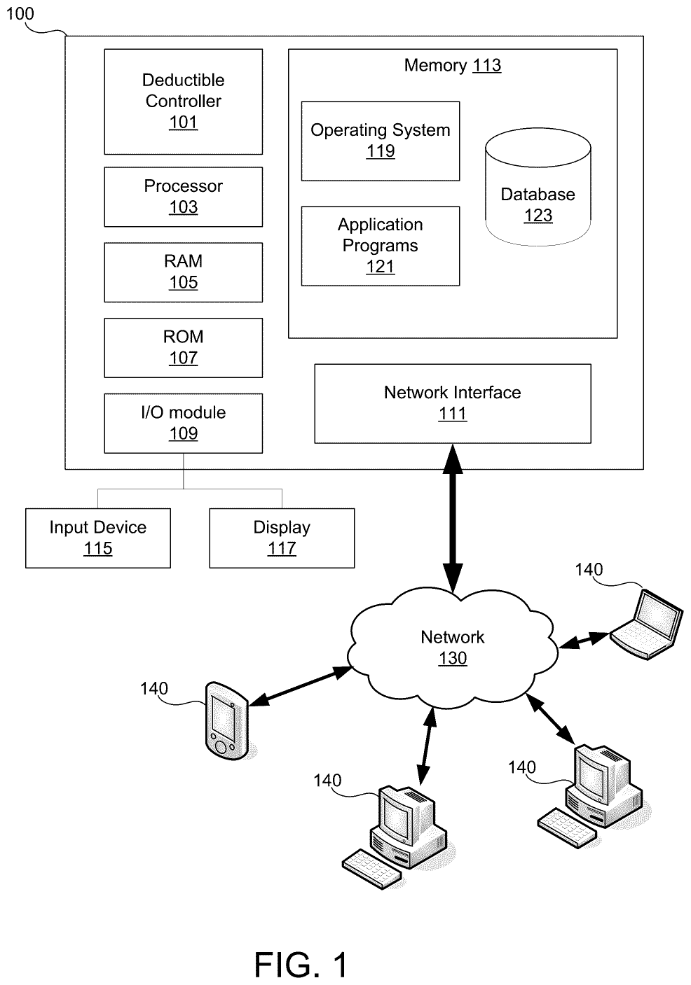

In one or more arrangements, the present disclosure may be implemented with a computing device. FIG. 1 illustrates a block diagram of an example computing device 100 that may be used according to an illustrative embodiment of the present disclosure. The computing device 100 may be similar to any available computing device, such as a personal computer (e.g., a desktop computer), server, laptop computer, notebook, tablet, smartphone, etc. The computing device 100 may have a deductible controller 101 for performing methods and executing instructions of a deductible determination program, which may be one of a plurality of programs in a suite of programs (including, e.g., a client-side program and server-side program) used by the deductible determination system to perform the functions described. The deduction controller 101 may, e.g., determine an insurance deductible, an adjusted insurance deductible, and a deductible payment plan. The deduction controller 101 may be implemented with one or more processors and one or more storage units (e.g., databases, RAM, ROM, and other computer-readable media), one or more application specific integrated circuits (ASICs), and/or other hardware components. Throughout this disclosure, the deduction controller 101 may refer to the software and/or hardware used to implement the deduction controller 101. The one or more processors of the deduction controller 101 may operate in addition to or in conjunction with another general processor 103 of the computing device 100. Both the deduction controller 101 and the processor 103 may be capable of controlling operations of the computing device 100 and its associated components, including RAM 105, ROM 107, an input/output (I/O) module 109, a network interface 111, and memory 113.

The I/O module 109 may be configured to be connected to an input device 115, such as a microphone, keypad, keyboard, touchscreen, and/or stylus through which a user of the computing device 100 may provide input data. The I/O module 109 may also be configured to be connected to a display device 117, such as a monitor, television, touchscreen, etc., and may include a graphics card. The display device 117 and input device 115 are shown as separate elements from the computing device 100, however, they may be within the same structure. Using the input device 115, system administrators may update various aspects of the deduction determination program, such as rules for determining a current driving situation, rules for determining ownership of property (vehicle or home), rules for adjusting a deductible (including rules for selecting an appropriate algorithm to make such determination), etc. On some computing devices 100, the input device 115 may be operated by users (e.g., customers) to interact with the deductible determination program, including providing user information, user preferences, user financial data, and other information such as route information for an upcoming trip, vehicle information, driver information, property ownership information, etc. Meanwhile, the display device 117 may assist the system administrators and users to confirm/appreciate their inputs. Also, the determined deductibles may be output to users and system administrators via display devices 117.

The memory 113 may be any computer readable medium for storing computer executable instructions (e.g., software). The instructions stored within memory 113 may enable the computing device 100 to perform various functions. For example, memory 113 may store software used by the computing device 100, such as an operating system 119 and application programs 121, and may include an associated database 123.

The network interface 111 allows the computing device 100 to connect to and communicate with a network 130. The network 130 may be any type of network, including a local area network (LAN) and/or a wide area network (WAN). For example, the network may include one or more of a variety of networks, such as the Internet, a cellular network, satellite network, or public switched telephone network. Through the network 130, the computing device 100 may communicate with one or more other computing devices 140, such as laptops, notebooks, smartphones, personal computers, servers, etc. The computing devices 140 may also be configured in a similar manner as computing device 100. In some embodiments the computing device 100 may be connected to the computing devices 140 to form a “cloud” computing environment.

The network interface 111 may connect to the network 130 via communication lines, such as coaxial cable, fiber optic cable, etc. or wirelessly using a cellular backhaul or a wireless standard, such as IEEE 802.11, IEEE 802.15, IEEE 802.16, etc. In some embodiments, the network interface may include a modem. Further, the network interface 111 may use various protocols, including TCP/IP, Ethernet, File Transfer Protocol (FTP), Hypertext Transfer Protocol (HTTP), etc., to communicate with other computing devices 140. In some embodiments, the computing device may include multiple network interfaces 111 for communicating using different protocols or standards or over different networks.

FIG. 1 is an example embodiment of a computing device 100. In other embodiments, the computing device 100 may include fewer or more elements. For example, the computing device 100 might not include the processor 103 in addition to one or more processors of the deductible controller 101. On the other hand, the computing device 100 may be a mobile device (e.g., a smartphone, tablet, etc.), and thus, may also include various other components, such as a battery, speaker, and/or antennas (not shown). Also, the computing device 100 may be a vehicle computing device 100 (either installed by a vehicle manufacturer or as an aftermarket part) having vehicle compatible elements, such as a port for an on-board diagnostic connector or ports for other vehicle sensors (e.g., tire pressure sensors, engine temperature sensors, etc.). For example, the computing device 100 may be home connected device (e.g., smoke detector, thermostat, video device, image device, audio device) including one or more sensors, and other components.

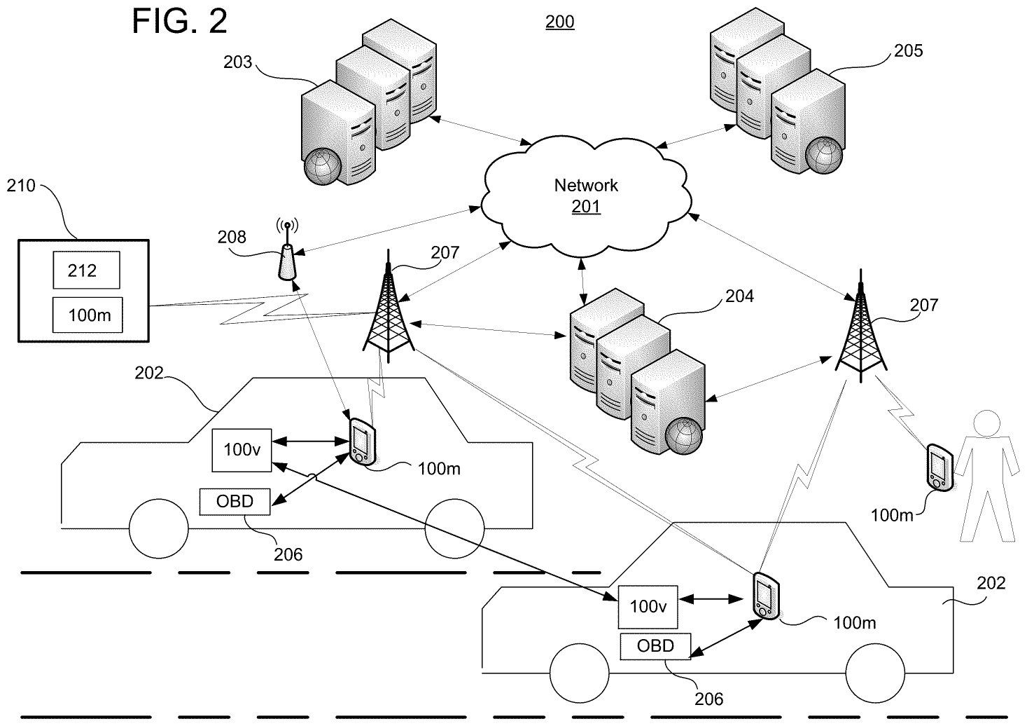

The methods and software for determining deductibles as disclosed herein may be implemented on one or more computing devices 100 used in various network environments. FIG. 2 illustrates an example network environment 200 for implementing methods according to the present disclosure. As shown in FIG. 2, the network environment 200 may include a network 201 configured to connect computing devices (e.g., mobile computing devices 100m) within or associated with vehicles 202, home 210 including one or more sensors 212, one or more third party servers 203, one or more service provider servers 204, and one or more deductible determination servers 205. Collectively, these computing devices may form a deductible determination system. The network 201 may be any type of network, like the network 130 described above, and use one or more communication protocols (e.g., protocols for the Internet (IP), Bluetooth, cellular communications, satellite communications, etc.) to connect computing devices and servers within the network environment 200 so they may send and receive communications between each other. In particular, the network 201 may include a cellular network and its components, such as cell towers.

For example, a mobile computing device 100m (e.g., a smartphone) of a person in a vehicle 202 may communicate, via a cellular backhaul of the network 201, with a deductible determination server 205 to transmit information regarding a current driving condition and receive an adjusted deductible. While FIG. 2 illustrates that the mobile computing devices 100m may connect to the network 201 while within vehicles 202, it should be understood that these same mobile computing devices 100m may connect to the network 201 even if they are removed from the vehicles 202. For example, a mobile computing device 100m being used by a user that is not driving may connect to the network 201. In an aspect of the present application, a user that is not driving (e.g., a passenger or person not in a vehicle) may use the mobile computing device 100m to review past deductibles provided in past trips that the user has been on.

For example, as shown in FIG. 2, a mobile computing device 100m (e.g., smart phone) of a person in a home 210 may communicate, via a cellular backhaul of the network 201, with a deductible determination server 205 to transmit information regarding a current condition of the home, and receive a deductible, an adjusted deductible, or a deductible payment plan. For example, one or more sensors 212 located within the home 210 or proximate the home 210 may communicate with the deductible determination server 205 to transmit information regarding a current condition, changes in a condition of the home 210, or indication of owning the home 210. In some embodiments, the deductible determination server 205 may send a deductible, an adjusted deductible, or offer for a deductible payment plan to the home 210 via a computing device in communication with the home 210 (e.g., mobile computing device 100m, device in communication with the one or more sensors 212.

FIG. 2 illustrates two vehicles 202. However, the deductible determination system may be configured to communicate with computing devices in more vehicles 202 (in particular, in a large volume of vehicles 202) simultaneously so that it may provide adjusted deductibles for multiple drivers simultaneously. Also, although FIG. 2 depicts the vehicles 202 as cars, the vehicles 202 may be any type of vehicle, including a motorcycle, bicycle, scooter, drone (or other automated device), truck, bus, boat, plane, helicopter, etc. Further, although FIG. 2 depicts the vehicles 202 being in close proximity to each other, it should be understood that the vehicles 202 may be in separate locations (e.g., such that they cannot communicate directly with each other).

FIG. 2 also illustrates an example subsystem within the network environment 200.

Specifically, FIG. 2 illustrates an example arrangement of computing devices that may exist within one or more of the vehicles 202. As shown in FIG. 2, a vehicle 202 may include a mobile computing device 100m, a vehicle computing device 100v, and an on board diagnostic (OBD) device 206 having a connector for connecting to an on board diagnostic connector (e.g., an OBD II port). The mobile computing device 100m may be carried into the vehicle 202 by a person. In some cases, more than one mobile computing device 100m may be in a vehicle 202. For example, both a driver and passenger may have their own mobile computing devices 100m that they carry with them into the same vehicle 202. The mobile computing device 100m may be any mobile computing device (e.g., a smartphone, tablet, etc.) that is associated with a driver or passenger of the vehicle 302.

The mobile computing device 100m may be configured in a similar manner to the computing device 100 of FIG. 1, and therefore, may include a deductible controller 101. The mobile computing device 100m may be configured to execute a deductible determination program that adjusts a deductible and/or provides a user interface for a user to provide inputs to and receive outputs from the deductible determination system. Such a client-side deductible determination program may be downloaded or otherwise installed onto the mobile computing device 100m using known methods. Once installed onto the mobile computing device 100m, a user may launch the client-side deductible determination program by, for example, operating buttons or a touchscreen on the mobile computing device 100m. Additionally, or alternatively, the mobile computing device 100m may be configured to execute a web browser (e.g., an application for accessing and navigating the Internet) to access a web page providing an interface for the deductible determination system. In some embodiments, the mobile computing device 100m may also be configured to collect drive data using, e.g., its accelerometer, GPS, gyroscope, etc. Drive data may include vehicle telematics data or any other data related to events occurring during a vehicle's trip (e.g., an impact to a part of the vehicle, a deployed airbag, etc.). Drive data may also include location information, such as GPS coordinates, indicating the geographical location of the mobile computing device 100m.

In some embodiments, the mobile computing device 100m may communicate (e.g., via Bluetooth) with a vehicle computing device 100v. As mentioned above and as shown in FIG. 2, a vehicle 202 may include a vehicle computing device 100v. The vehicle computing device 100v may be configured in a similar manner to the computing device 100 of FIG. 1, and therefore, may include a deductible controller 101. Further, the vehicle computing device 100v may be configured to execute the client-side deductible determination program that facilitates collection of data used to determine the current driving situation with respect to the vehicle. Such a client-side deductible determination program may be downloaded or otherwise installed onto the vehicle computing device 100v using known methods. Once installed onto the vehicle computing device 100v, a user may launch the client-side deductible determination program by, for example, operating buttons or a touchscreen on the dashboard of the corresponding vehicle 202. In some examples, the client-side deductible determination program may be automatically launched whenever the vehicle 202 is started or put in gear. Additionally, or alternatively, the vehicle computing device 100v may be configured to execute a web browser to access a web page providing an interface for the deductible determination system. In some embodiments, the vehicle computing device 100v may be configured to collect drive data using, e.g., its accelerometer, GPS, gyroscope, etc. As mentioned above, this drive data may include vehicle telematics data or any other data related to events occurring during a vehicle's trip (e.g., an impact to a part of the vehicle, a deployed airbag, or other event triggered by a sensor of the vehicle). The vehicle 202 may have a GPS installed therein, and therefore, the vehicle computing device 100v may also collect GPS coordinates.

Moreover, in some embodiments, the vehicle computing device 100v may be configured to collect drive data from other nearby vehicles 202. For example, as shown in FIG. 2, a vehicle computing device 100v of one vehicle 202 may directly communicate with a vehicle computing device 100v of another vehicle 202. Standards for implementing such vehicle-to-vehicle communication are expected to be developed. Any such standards may be used by one vehicle computing device 100v to collect drive data from another vehicle computing device 100v. Further, any information collected by a vehicle computing device 100v may be shared with a mobile computing device 100m within the same vehicle via, e.g., a Bluetooth or other local connection.

Further, the vehicle computing device 100v may be a system including multiple devices. For example, the vehicle computing device 100v may include a microphone and/or speakers for notifying (or alerting) the user about a deductible adjustment. Additionally, the vehicle computing device 100v may include or be configured to interface with one or more vehicle sensors (e.g., fuel gauge, tire pressure sensors, engine temperature sensors, speedometers, odometers, etc.). Thus, the vehicle computing device 100v may be configured to determine a current driving condition based on various factors. For example, the vehicle computing device 100v may determine that the current driving situation is dangerous (or less safe than desired) because tire pressure in one or more tires is low. Such a determination may cause the deductible to be increased. The deductible may be increased to an adjusted deductible and remain at the adjusted deductible until the tire pressure is improved or may steadily increase over time (or as miles accumulate) until the tire pressure is improved. In either case, it may be expected that the increase will incentivize or encourage the user to correct the tire pressure, and thus, improve the safety of the vehicle, which in turn may improve the current driving situation.

In some embodiments, one or more of the vehicles 202 may be autonomous or in an autonomous mode (e.g., auto-pilot mode). An autonomously controlled vehicle 202 may be controlled by its vehicle computing device 100v and/or a remote computing device. The vehicle computing device 100v may employ sensors for inputting information related to a vehicle's surroundings (e.g., distance from nearby objects) and use the inputted information to control components of the vehicle s 202 to steer the vehicle 202.

The vehicle computing device 100v may also interface with the mobile computing device 100m via a wired connection (e.g., USB) or via the OBD device 206. The OBD device 206 may be connected to the OBD II connector/port of the vehicle 202, which is typically located beneath the steering wheel of the vehicle 202. The OBD device 206 may facilitate sharing of drive data collected by the vehicle computing device 100v with the mobile computing device 100m. In some embodiments, the OBD device 206 may be used to collect drive data itself. For example, the OBD device 206 may include a GPS receiver, accelerometer, gyroscope, etc. in order to collect GPS coordinates, acceleration data, deceleration data, turning data, etc. Also, the OBD device 206 may include a microphone to collect audio data from within the vehicle 202 to determine a noise level within the vehicle. In some embodiments, the OBD device 206 may communicate with the deductible determination servers 205, without the use of a mobile computing device 100m, to provide drive data to the deductible determination servers 205. As such, in some instances, a mobile computing device 100m or vehicle computing device 100v might not be required to perform deductible adjustments on-the-fly.

Still referring to FIG. 2, the mobile computing devices 100m may communicate with other devices of the deductible determination system (e.g., third party servers 203, service provider servers 204, and/or deductible determination servers 205) via the network 201. As shown in FIG. 2, the mobile computing devices 100m may connect to the network 201 via a cell tower 207 or access point 208. For example, a mobile computing device 100m may transmit and receive cellular signals via a cell tower 207 so that the mobile computing device 100m may communicate with the deductible determination system while traveling in a moving vehicle 202. Text messages may be sent to/from the mobile computing devices 100m via the cell towers 207 of a cellular backhaul at various times, and in particular when the mobile computing devices 100m are traveling within vehicles 202. In addition, mobile computing devices 100m may send/receive other information via the cell towers 207. For example, a mobile computing device 100m may receive traffic information (which may be used to determine deductible adjustments as described herein) from a third party server 203 via a cell tower 207 providing cellular coverage to an area in which the mobile computing device 100m is located. In some cases, information may be relayed via multiple cell towers 207 to reach a mobile computing device 100m.

Additionally, or alternatively, a mobile computing device 100m or vehicle computing device 100v may transmit and receive other wireless signals (e.g., WiFi signals) to/from access points 208 set up along roads, highways, etc. so that the mobile computing device 100m and/or vehicle computing device 100v may communicate with the deductible determination system while the vehicle 202 is moving. For example, a mobile computing device 100m may receive weather information (which may be used to determine deductible adjustments) from a third party server 203 via an access point 208 as the vehicle 202 carrying the mobile computing device 100m passes the access point 208. Moreover, a vehicle computing device 100m may transmit drive data, indicating that it is speeding (and thereby indicating that the driving behavior is not safe), via a nearby access point 208 alongside the road, to the deductible determination system (which may use such information for determining an adjustment to the deductible). Although only one access point 208 is shown in FIG. 2, additional access points may be used. In some cases, information may be relayed via multiple access points 208.

FIG. 2 also illustrates third party servers 203. Herein, a server may refer to any network computing device specially configured to communicate over a network and/or any other type of computing device. The third party servers 203 may be owned or controlled by various entities that have been tasked with or employed for collecting or entering data that may be used as a factor in determining a level of safety of a current driving situation and/or a current home situation. For example, a third party server 203 may be a server of a company that collects or generates weather information or a server of a government office/agency that provides accident reports. The third party servers 203 may be configured in a similar manner as the computing device 100 of FIG. 1. In some embodiments, the third party servers 203 may be particularly configured to handle (e.g., receive and respond to) a large volume of requests for information. The third party servers 203 may store or be connected to databases that store various types of information that may be used to evaluate a driving situation. For example, third party servers 203 may provide weather information for determining weather conditions, traffic information for determining traffic conditions, road information (including road maps) for determining road conditions, construction information for determining construction zones, etc. Further, the third party servers 203 may communicate with other third party or fourth party devices that include sensors for measuring and collecting data that could be used to evaluate a current driving situation. For example, a third party server 203 may receive its weather information from data collected by a thermometer, barometer, etc. Also, a third party server 203 may receive traffic information from images captured with a camera. Although FIG. 2 depicts the third party servers 203 as being collocated, it should be understood that the third party servers 203 may be at separate locations. For example, one third party server 203 at a first location may provide weather information, while another third party server 203 at a second location (separate from the first location) may provide traffic information.

The third party servers 203 may receive location information (e.g., GPS coordinates) corresponding to a location of a mobile computing device 100m, determine relevant information for that location, and return the relevant information to the requesting mobile computing device 100m (or another appropriate device in the system such as one of the deductible determination servers 205) via the network 201. The third party servers 203 may execute a server-side deductible determination program for handling requests so that requests are properly parsed and responses are properly packaged for delivery to mobile computing devices 100m, service provider computing devices 204, and/or deductible determination servers 205.

FIG. 2 also illustrates service provider servers 204. The service provider servers 204 may be configured in a similar manner as the computing device 100 of FIG. 1. In some embodiments, the service provider servers 204 may include or be a part of a subsystem including components of a cellular network (e.g., Global System for Mobile Communications (GSM) network), such as base stations or a mobile switching center (MSC). In some embodiments, the service provider servers 204 may be configured to connect one or more cellular backhaul systems (including cell towers 207) with other components of the deductible determination system (e.g., third party servers 203 and deductible determination servers 205). For example, a mobile computing device 100m may want insurance related information while it is in a moving vehicle 202, and therefore, may send a cellular signal to a nearby cell tower 207 requesting such information. The cell tower 207 may relay the cellular signal to a service provider computing device 204, which may decode/demodulate the cellular signal and produce a different signal (e.g., IPv4/IPv6 packet) that may be received by the deductible determination servers 205. The service provider computing device 204 may also receive signals from deductible determination servers 205 or third party servers 203 and generate cellular signals that may be used to transfer information to mobile computing devices via cell towers 207. For example, a service provider computing device 204 may inform a deductible determination server 205 that text messages and/or phone calls are blocked from being sent to a user, so that the deductible determination server 205 may use such information to determine an adjustment (e.g., a decrease) of the deductible.

The service provider computing devices 204 may be maintained, controlled, and/or owned by cellular network providers (e.g., AT&T, VERIZON, etc.). Different service provider computing devices 204 may be used for different cellular network providers.

FIG. 2 also depicts deductible determination servers 205. The deductible determination servers 205 may belong to an insurance company that provides insurance (e.g., automotive insurance, home insurance), or to another company that manages and maintains the deductible determination servers 205 on behalf of (or for providing a service to) an insurance company. The deductible determination servers 205 may be configured in a similar manner as the computing device 100 of FIG. 1, and therefore, may include a deductible controller 101. The deductible determination servers 205 may be specially configured (e.g., programmed) to communicate with a plurality of mobile computing devices 100m vehicle computing devices 100v, and/or OBD devices 206. In particular, the deductible determination servers 205 may be configured to receive data from mobile computing devices 100m indicating that a user is driving, what vehicle the user is driving, a condition of the vehicle itself, a condition inside or outside of the vehicle, and where a user is driving. Based on the information received from the mobile computing device 100m and other information (e.g., information received from third party servers 203 or information stored in databases within or connected to the deductible determination servers 205), the deductible determination servers 205 may determine whether to adjust a deductible and if so, by the amount of the adjustment. The deductible determination servers 205 may also report the adjustments to the mobile computing device 100m. Further, based on the information received from the mobile computing device 100m and other information (e.g., information received from third party servers 203 or information stored in databases within or connected to the deductible determination servers 205), the deductible determination servers 205 may determine a deductible payment plan for a deductible. The determination of a deductible, adjustments to a deductible, and a deductible payment plan may use artificial intelligence (AI) and/or machine learning (ML). Artificial intelligence and/or machine learning may be used to identify patterns, trends, sentiment from sensor data and/or financial data associated with the user. Artificial intelligence and/or machine learning may be trained based on historical sensor data and/or financial data to determine deductibles, adjustments to deductibles, and/or eligibility for deductible payment plans for future users.

In some embodiments, the deductible determination servers 205 may receive and store drive data on a driver-by-driver basis. For example, the deductible determination servers 205 may store drive data received from a first mobile computing device 100m in association with a driver associated with the first mobile computing device 100m, and store other drive data received from a second mobile computing device 100m in association with another driver associated with the second mobile computing device 100m. In this manner, the deductible determination servers 205 may have access to a driving behavior history of different drivers. The deductible determination servers 205 may include storage for storing this information or may be connected to local or remote databases used to store such information.

The deductible determination servers 205 may also store (or access databases that store) other insurance related information, such as information that may be associated with an insurance policy (e.g., automotive insurance policy, home insurance policy, etc.). For example, the deductible determination servers 205 may store or access insurance premiums, insurance deductibles, an insurance claim history, or accident reports as well as user information of an insurance policy, such as phone numbers of drivers on an insurance policy.

In some embodiments, the deductible determination servers 205 may store (or access databases that store) financial information (or data), such as information (or attributes) including a user's credit history, Fair Issac Corporation (“FICO”) score, history of loan payments such as home or auto loans, history of paying off loans early, history of payment options for bills such as autopay or non-autopay, and/or monetary assets. The deductible determination servers 205 may store (or access databases that sore) a financial profile associated with a user. The financial profile may include one or more attributes obtained from the financial information. For example, monetary assets may include a type of monetary account (e.g., bank account or retirement savings account), number of monetary accounts, and/or other monetary assets. For example, the financial data may include type of financial institution (e.g., small, mid, large, credit union, nonprofit, commercial, etc.) or a differentiation between financial institutions (e.g., large vs. small, credit union vs. commercial, etc.). For example, the deductible determination servers 205 may store or access one or more monetary values associated with a user's financial record.

In some embodiments, the deductible determination servers 205 may also track participation in the deductible determination system and maintain a log of deductible adjustments on a per person or per policy basis. For example, the deductible determination servers 205 may store in memory (e.g., internal memory of the deductible determination servers 205 or memory of another database in communication therewith) a log or record of all deductible adjustments so that users can review their past deductible adjustments and see how their driving behavior impacts their deductible. In some examples, the log may include a reason for the adjustment. For example, if the deductible was decreased because the driver drove in good weather conditions, the log may indicate that good weather conditions were the reason for the deductible and may also, in some instances, indicate the precise weather conditions (e.g., sunny, good visibility, etc.).

In some embodiments, the deductible determination servers 205 may track a financial record and maintain a log of deductible payment plans on a per person basis or per policy basis. For example, the deductible determination servers 205 may store in memory (e.g., internal memory of the deductible determination servers 205 or memory of another database (e.g., financial institution) in communication therewith) a log or record of financial payments to loans (e.g., home or auto), and/or monetary assets (e.g., bank accounts or other monetary accounts). For example, users can see how their driving behavior and financial record impact their eligibility for a deductible payment plan. For example, users may be eligible for the deductible payment plan if the user has a low number of accidents or no accidents on record, and has monetary assets that can cover the deductible. For example, users may be eligible for the deductible payment plan if sensors associated with a user indicate home or auto ownership, and the user has monetary assets that can cover the deductible.

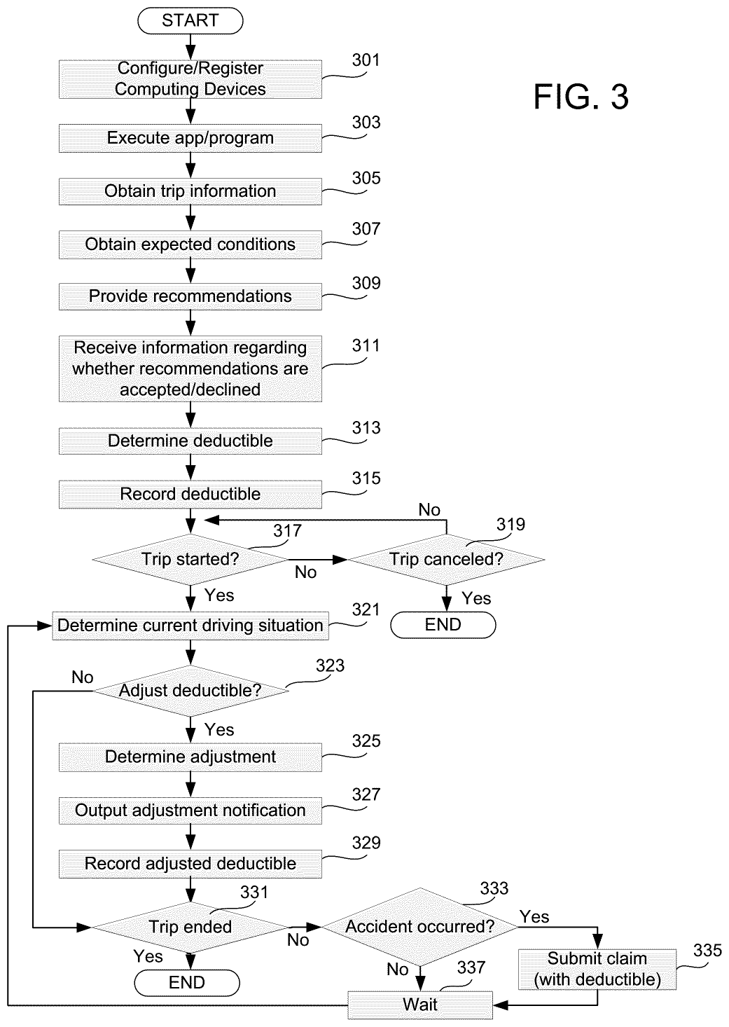

FIG. 3 illustrates a flow diagram for an example method in accordance with aspects of the present disclosure. More specifically, FIG. 3 illustrates a plurality of steps of a method for adjusting deductibles on-the-fly (e.g., in real time) based on a current driving situation (e.g., real time driving conditions). The steps of FIG. 3 may be performed by various devices disclosed herein, and in particular a mobile computing device 100m, such as a cell phone of a driver of the vehicle 202, a vehicle computing device 100v, or a deductible determination server 205. Herein, where the system is described as performing a step or process, it should be understood that any device in the system may perform the step or process alone or in conjunction with another device of the system (or another device connected thereto). One or more of the steps of FIG. 3 may be performed by executing a client-side deductible determination program, a server-side deductible determination program, and/or operating a particularly configured computing device of the deductible determination system. As a result of the method of FIG. 3, an adjusted deductible may be determined and output to a user on-the-fly so that when mobile computing device 100m users are driving they might be incentivized or encouraged to improve the driving situation in which they are driving. Consequently, performance of the method of FIG. 3 may lead to a reduction in traffic accidents, which may lead to a reduction in costs of insurance companies, which in turn may translate into lower rates for customers of insurance companies. Additionally, performance of the method of FIG. 3 may lead to lower deductibles, which may increase customer satisfaction, which in turn may lead to customer loyalty and customer retention.

The method of FIG. 3 may begin with a step 301 of configuring and/or registering the computing devices (e.g., mobile computing device 100m, vehicle computing device 100v) of the deductible determination system. For example, configuring a mobile computing device 100m of a customer of an insurance company may include downloading and installing a deductible determination program (e.g., a client-side deductible determination program). Different mobile computing devices 100m and vehicle computing devices 100v may install different versions of the deductible determination program depending on a platform of the mobile computing device 100m or vehicle computing device 100v. For example, a mobile computing device running the iOSTM™ operating system may download a different version of the deductible determination program than a device running the ANDROID™ operating system.

Step 301 may also include registering a computing device (e.g., mobile computing device 100m or vehicle computing device 100v) with the organization (e.g., an insurance company) providing the deductible determination system. Registering a computing device may include creating and/or logging into an account with an associated username and/or password. The account may be associated with the mobile computing device 100m and/or an insurance policy of a user of the mobile computing device 100m. To perform registration, the organization providing the insurance company may request various information, including information regarding a user device (e.g., device identifier, device make, device model, etc.), information regarding a user (e.g., name, birthdate, address, insurance policy number, etc.), and/or information regarding a vehicle (e.g., make, model, year, vehicle identification number (VIN), etc.). Registration may also include setting up an account for maintaining a record of deductible adjustments.

In some embodiments, when registering with the deductible determination system, a user may create a profile. The profile may include certain user preferences so that a customized experience may be realized.

In step 303, the client-side deductible determination program installed on the mobile computing device 100m may be executed. Where the client-side deductible determination program is an “app” on a smartphone, step 303 may include a user selecting the “app” and the operating system of the smartphone running the “app.” The client-side deductible determination program may run continuously in the background of the mobile computing device 100m so that it is configured to adjust deductibles whenever a user is driving. In other words, the deductible determination program may run in the background of the mobile computing device 100m continuously so that users do not have to interact with the program each time they are about to begin a drive or end a drive. Because the client-side deductible determination program may run in the background it might not be distracting to users wishing to perform other operations with their mobile computing devices 100m, and therefore, users may be more likely to adopt the client-side deductible determination program. In some embodiments, once launched, the client-side deductible determination program may be launched automatically each time the mobile computing device 100m is powered on. Thus, if the mobile computing device 100m is turned off or its battery dies, the client-side deductible determination program may be automatically launched again when the mobile computing device 100m is turned back on or powered back up.

In some embodiments, the client-side deductible determination program may enter a sleep mode so as not to drain the battery of the mobile computing device 100m when the user is not driving. For example, in some embodiments, the client-side deductible determination may remain in a sleep mode to conserve battery power until a user begins driving.

In step 305, a mobile computing device 100m (e.g., using the client-side deductible determination program), a vehicle computing device 100v, a deductible determination server 205 (by way of a mobile computing device 100m or vehicle computing device 100v), or other device of the deductible determination system may obtain trip information. Step 305 may include obtaining route information indicating a route to be taken for an upcoming trip or trip currently underway. Step 305 may also include obtaining destination information indicating a destination for an upcoming trip or trip currently underway. Other trip information, such as a number of passengers, names of passengers, vehicle information indicating a make, model, year, etc. of a vehicle to be driven on a trip, and driver information indicating a name of a driver, may also be obtained at step 305.

Step 307 may include obtaining expected conditions for the trip. For example, weather conditions or road conditions that may be encountered on the trip may be obtained. These conditions may be obtained from information provided by third party servers 203. Such conditions may be based on the route information or destination information obtained in step 305. For example, using the destination of the trip, weather conditions that may be encountered along the way to the destination may be obtained. Also, for example, using route information indicating the route of the trip, information regarding road conditions of roads forming the route may be obtained.

In some embodiments, step 307 may include obtaining information regarding the vehicle 202 to be used for the trip. This information may be obtained from, for example, the vehicle computing device 100v (including, e.g., vehicle sensors). Examples of this information may include that tire pressure of the vehicle 202 is low, brake fluid of the vehicle 202 is low, brakes of the vehicle 202 are old or worn out (which may be determined based on number of miles driven and when the brakes were last replaced), windshield wipers of the vehicle 202 are old or worn out (which may be determined based on an amount of total time or number of times they have been used), or that the vehicle 202 otherwise needs maintenance.

In step 309, the deductible determination system may determine and provide recommendations to the driver of the trip. For example, the system may recommend that another driver (e.g., the wife of the intended driver, another colleague of the intended driver, etc.) be the driver for the trip. Also, the system may recommend that a different route be taken for the trip. For example, the system may determine that another route is safer and may recommend that the user take the other route for the trip. Other recommendations may include postponing the trip until the weather changes (e.g., until it stops raining) or making the trip at a different time (e.g., either earlier or later) so that the trip takes place at a time when there is less traffic (e.g., non-rush hour times) or better visibility (e.g., during the day instead of at night).

In some embodiments, an amount of an adjustment of a deductible or the new adjusted deductible that would be received if the recommendation is accepted may be provided in step 309 as well. For example, the mobile computing device 100m may display a message on its screen recommending that the user take a safer route different from the one intended and indicating that if the user takes the safer route their deductible may be decreased by $100. When providing recommendations in step 309, the system may also prompt the user whether they wish to accept or decline the recommendations.

Step 311 may include receiving information regarding whether a user accepted or declined one or more recommendations. It should be understood that a user may accept one recommendation and decline another recommendation. Accepting or declining a recommendation may be performed by a user by pressing a button or key on the mobile computing device 101m or vehicle computing device 100v (which may include, e.g., a display mounted on the dashboard of a vehicle 202).

In step 313, based on the expected conditions and information regarding whether recommendations were accepted or declined, the deductible determination system may determine a deductible for the trip. Acceptance of recommendations may result in lower deductibles. Moreover, in some examples, acceptance of a recommendation may result in a lower deductible than if the user had planned to take the recommended course of action in the first place. For example, the user's deductible may be lower in a case where the user selects a first route but then accepts a recommendation to take a second route (e.g., a safer route) than if the user were to have selected the second route from the start. Thus, the user may be especially rewarded for accepting recommendations. In some embodiments, the deductible may be output to the user (e.g., driver of the trip) at step 313 as well.

In step 315, the adjusted deductible may be recorded in memory (such as memory of a mobile computing device 100m, vehicle computing device 100v, deductible determination server 205, or any other device of the deductible determination system or any other memory of any computing device in communication with the system). The newly adjusted deductible or an amount of adjustment from a base deductible (e.g., the base deductible set in an insurance policy) may be recorded. A time may also be stored in association with the adjusted deductible. The time may represent a time at which the adjusted deductible becomes effective. If the vehicle is involved in an accident, the deductible in effect at the time of the accident may be the deductible used to determine what the policy holder is responsible for and what the insurance company is responsible for. The adjusted deductible may remain in effect until a new adjusted deductible is determined or for a predetermined time after it becomes effective (in the latter case, the deductible may revert back to the base deductible or some other deductible upon expiration of the predetermined time).

In some embodiments, the time recorded in step 315 may correspond to the time that the adjusted deductible was determined or a predefined time thereafter (e.g., 1 minute after the determination is made). In some embodiments, where the adjusted deductible is determined by a deductible determination server 205, the time may correspond to the time that the adjusted deductible was transmitted to the mobile computing device 100m or vehicle computing device 100v. In some embodiments, the time may correspond to the time that the adjusted deductible was output to the user. For example, the time may be a time that the mobile computing device 100m or vehicle computing device 100v displayed the adjusted deductible or played an audio message indicating the adjusted deductible.

In step 317, the system may determine whether a trip has started. This determination may be made based on an input from a user indicating the start of a trip. Additionally, or alternatively, this determination may be made based on automatically acquired information, such as information indicating whether a vehicle 202 is running or information indicating that the vehicle is moving (which may be assumed based on the mobile computing device 100m traveling above a certain speed).

If the deductible determination system determines that the trip has not started (No at step 317), the system may determine whether the trip has been canceled at step 319. In step 319, the system detects whether the trip has been canceled based on manual information and/or automatic information. For example, the user may indicate that the trip is canceled by pressing a button or key on a mobile computing device 100m or vehicle computing device 100v. The system may also assume the trip is canceled if the vehicle 202 is not turned on or moved within a certain period of time from, for example, execution of the client-side deductible determination program at step 303 or determination of the deductible at step 313.

If the trip is canceled (Yes at step 319), the process may end. Of course, the process may be repeated again in the future when the user goes to take another trip. It should be understood that the process of FIG. 3 may be performed multiple times as a user may make multiple driving trips.

If it is determined that the trip is not canceled (No at step 319), the system may repeat step 317. Effectively, the system may wait until it determines whether the trip is started or canceled.

Once it is determined that the trip has started (Yes at step 317), the deductible determination system may determine a current driving situation at step 321. Herein, a current driving situation may be a situation that the vehicle is in during a particular trip. The deductible determination system may select one or more of various factors for determining the current driving situation. Example factors include weather conditions (e.g., whether it is sunny, cloudy, rainy, etc.) at the vehicle's current location (or in proximity, e.g., within a mile, five miles, etc., of the vehicle), road conditions (e.g., slippery, road work in progress, etc.) the vehicle may encounter, traffic conditions (e.g., heavy, medium, light, etc.) at the vehicle's current location, type of roads (e.g., highways, one way street, street with medium, residential street, etc.) the vehicle is travelling on, conditions inside a vehicle 202 (e.g., noisy, distractions, etc.), conditions outside of the vehicle 202 but in the vehicle's proximity (e.g., towing a boat or trailer, tailgating, etc.), conditions of the vehicle 202 itself (e.g., needs maintenance), conditions of the driver (e.g., whether the driver sleepy, intoxicated, etc.) which may be captured using a camera or other sensor (e.g., breathalyzer), choices a driver makes (e.g., whether to allow text messages or phone calls), driving behavior (e.g., hard braking events, speeding, hard acceleration, hard turning, etc.), number of passengers in the vehicle 202, accident history at the current location (e.g., the driver's accident history, general public's accident history, or accident history of an entity's customers such as the accident history of an insurance company's customers), insurance company claims associated with the current location (e.g., number of insurance claims made for accidents occurring at the current location, damage claimed in insurance claims at the current location), traffic lane (e.g., left lane, middle lane, right lane, etc.), and time of day (e.g., 8 am or between 3 pm and 5 pm).

In some embodiments, factors not specific to the current driving situation may also be selected for consideration in determining the deductible. For example, the driver's age, gender, eyesight, etc. may be selected. In some embodiments, the factors selected may vary. The factors selected may depend on the driver or insurance policy. Certain factors may be considered for one driver, but not another. The factors selected may also depend on how long a driver has been a customer of an insurance company (e.g., how long an insurance policy has been active). Also, the factors selected may depend on what information is available at a time of making the determination. Moreover, factors selected may depend on other factors. For example, if weather conditions are good and/or it is during the daytime, the system might not consider the type of roads.

Once the factors to consider have been selected, the deductible determination system may obtain information associated with the selected factors. For example, if the system selects to consider traffic information, the system may poll a third party server 203 to obtain traffic information. Specifically, the system may send the third party server 203 a current location (e.g., GPS coordinates) of the vehicle 202 and receive traffic information (e.g., whether the traffic in the current location is light, medium, heavy, very heavy, etc.) in return.

The information for the selected factors may come from various sources depending on what information is being sought. Sources may include any of the computing devices in the deductible determination system, including one or more third party servers 203, one or more service provider servers 204, one or more deductible determination servers 205, the mobile computing device 100m, the vehicle computing device 100v, the OBD device 206, etc. For example, information on whether the user has chosen to block text messages or phone calls may come from the mobile computing device 100m or service provider server 204. Information on whether the vehicle 202 is currently speeding may come from the vehicle computing device 100v or OBD device 206. Information on a number of insurance claims or total amount of damage claimed associated with the current location of the vehicle 202 may be retrieved from one or more deductible determination servers 205 or one or more databases (e.g., computing devices of an insurance company) connected thereto.

In some embodiments, the deductible determination system may convert (or translate) the obtained information for each selected factor into a standard format or score (e.g., value). In some cases, the deductible determination system may determine a value for each piece of obtained information. For example, the system may convert information that the current traffic is light into a score of “1” and convert information that the current traffic is heavy into a score of “5.” Also, the system may, for example, set a certain variable (e.g., a Boolean variable) that is designated for factoring in whether it is raining to have a certain value (e.g., a value of “true”) if the obtained weather information indicates that it is indeed raining where the driver is driving. Converting or translating the obtained information may assist the system in considering a plurality of different types of information in a single determination of the current driving situation. The obtained information in its raw form might not be suitable for use in determining the current driving situation, and thus, it may be necessary to first convert the raw information.

The obtained information or converted information may be used in an algorithm for determining (or computing) a safety score (or level of safety). In some embodiments, different algorithms may be available and the system may choose which algorithm to use. The algorithm may be selected based on the type of driver or the insurance policy of the driver.

Further, step 321 may include selecting weights used by the algorithm to weigh the obtained information or converted information appropriately. A weight may be a coefficient for a variable designated for a particular type of condition. Different conditions may be weighted differently. For example, weather conditions may be weighted more heavily than traffic conditions, which may be weighted more heavily than a noise level inside the vehicle 202.

Using any determined weights and the obtained information (in either its raw or converted form), an algorithm for determining the safety score for the current driving situation may be executed. Execution of the algorithm may result in a numeric value that may represent a safety score for the current driving situation. In some cases, this safety score may be on a scale of 1 to 100, 1 to 5, or any other scale.

In step 323, the deductible determination system may determine whether to adjust the deductible. This determination may be based on the safety score determined in step 321. For example, the deductible determination system may determine to adjust the deductible if the safety score is above a threshold, below a threshold, or has changed by a certain amount from a previously calculated safety score for the same trip. For example, if the safety score exceeds an 80 out of 100, the system may determine to adjust the deductible, whereas a safety score of 75 might not trigger the system to adjust the deductible. Additionally, or alternatively, if the safety score has changed (e.g., increased or decreased) by a predefined threshold (e.g., 5 points) from a safety score previously determined during the same trip, the system may determine to adjust the deductible. The thresholds described herein may differ for different trips or different drivers. By including this step of determining whether to adjust a deductible, the process may regulate how often deductibles are adjusted. In some cases, it might not be desirable to frequently adjust the deductible because frequent adjustments may, for example, distract the driver.

If the system determines not to adjust the deductible (No at step 323), the system may proceed to step 331 to determine whether the trip has ended as described in further detail below. It should be understood that the system may repeat steps 321 and 323 multiple times during a single trip.

If the system determines to adjust the deductible (Yes at step 323), the system may determine the adjustment at step 325. Determining the adjustment to the deductible may include determining a new deductible or determining an amount by which to change a policy holder's current deductible (which may be the standard deductible or a recently adjusted deductible). Step 325 may include obtaining the standard deductible set forth in an insurance policy or the most recently adjusted deductible. The adjustment to the deductible for the current trip may be determined using the safety score. The deductible adjustment for the current trip may also be determined using information regarding past accidents or past insurance claims for (a) the current route or road being taken for the current trip, (b) the type of driver or driving history/record of the current driver, and/or (c) the current driving situation (which may be represented by the safety score).

The information regarding past accidents (e.g., vehicle collisions involving multiple vehicles, vehicle crashes, and other moving vehicle accidents) may indicate a type of accident (e.g., vehicle collision, vehicle crash, etc.), the driver(s) involved in the accident, the party responsible for the accident, the vehicle(s) involved in the accident, condition(s) at the time of the accident, and a location of the accident. This information may be stored in association with each other for each accident and this information may exist for a plurality of accidents so that a significant amount of information is available for adjusting deductibles.

The information regarding past insurance claims (e.g., automotive insurance claims) may indicate a policy holder who submitted the claim, an amount of damage claimed, a reason or event (e.g., accident, theft, vandalism, natural disaster, etc.) that led to the insurance claim being issued, a location of the event that led to the insurance claim being issued, a date and/or time of the event that led to the insurance claim being issued, a weather condition (or any other condition) during the event that led to the insurance claim being issued, a party/entity responsible for the event that resulted in the damage, the driver if the claim relates to a moving vehicle accident, etc. This information may be stored in association with each other for each claim and this information may exist for a plurality of claims so that a significant amount of information is available for adjusting deductibles.

The information regarding past accidents or past insurance claims may be obtained from the deductible determination servers 205 and/or one or more databases (or other devices) connected thereto. Also, information regarding past accidents may be extracted from information regarding past insurance claims. As discussed, insurance claim information may indicate a reason or event (e.g., accident, theft, vandalism, natural disaster, etc.) that led to the insurance claim being issued. Thus, accident information may be collected (or extracted) from such insurance information.

The following are some examples of adjustment determinations that may be made by the deductible determination system using, e.g., a deductible controller 101 (which may use, e.g., a deductible determination program). In the following examples, various values are given for ease of explanation and to aid in understanding the possible relationships (e.g., linear, logarithmic, exponential, etc.) between the information used to determine the adjustment and the end result of the determination. It should be understood that other values and relationships may be used in practice.

An example of an adjustment determination at step 325 for a current trip may include using information that only three (3) accidents occurred along the route that is being taken for the current trip to determine that the deductible should be decreased from $1,000 to $900. In comparison, if the same information were to indicate that seven (7) accidents occurred along the route that is being taken for the current trip, the system may determine to adjust the deductible to $950 instead. In contrast, if the same information were to indicate that a large number of accidents (e.g., 50 accidents within the last year) have occurred along the route, the system may determine to increase the deductible from $1,000 to $1,020.

As another example, an adjustment determination at step 325 for a current trip may include using information that the current driver has previously been in an accident on the same route that is being taken for the current trip to determine that the deductible should be increased from $500 to $525. In comparison, if the same information were to indicate that the driver has previously been in two accidents on the same route that is being taken for the current trip, the system may determine to adjust the deductible from $500 to $600. In contrast, if the same information were to indicate that the current driver has never been in an accident on the same route that is being taken for the current trip, the system may determine to decrease the deductible from $500 to $450.

As yet another example, an adjustment determination for a current trip may include using information that drivers similar to the current driver (e.g., similar in age, gender, interests, geographical location, etc.) have previously been in twenty (20) accidents on the same route that is being taken for the current trip to determine that the deductible should be increased from $750 to $800. In comparison, if the same information were to indicate that other similar drivers (e.g., drivers of similar type) have previously been in one hundred (100) accidents on the same route that is being taken for the current trip, the system may determine to adjust the deductible from $750 to $1,000. In contrast, if the same information were to indicate that the other similar drivers have only been in three (3) accidents (or never been in an accident) on the same route that is being taken for the current trip, the system may determine to decrease the deductible from $750 to $500.

Further, an adjustment determination for a current trip may include using information that accidents are 15% more likely in cases where the safety score matches the current safety score to determine that the deductible should be increased from $500 to $530. In comparison, if the same information were to indicate that accidents are 20% less likely to occur in cases where the safety score matches the current safety score, the system may decrease the deductible from $500 to $460.

In some cases, a baseline safety score may be predetermined and deductibles may be adjusted up or down depending on whether the actual safety score for the current driving situation is greater than or less than the baseline safety score, respectively. For example, where a baseline safety score is set to 80 (out of 100), the system may increase the deductible by $50 if an actual safety score of 73 is determined for the current driving situation or decrease the deductible by $50 if an actual safety score of 87 is determined for the current driving situation.

Still referring to step 325, the adjustment determination for a current trip may include using insurance information that only one (1) claim resulted from an accident that occurred along the route that is being taken for the current trip to determine that the deductible should be decreased from $500 to $400. In comparison, if the same insurance information were to indicate that five (5) claims resulted from accidents that occurred along the route that is being taken for the current trip, the system may determine to adjust the deductible to $450 instead. In contrast, if the same insurance information were to indicate that a large number of claims (e.g., 30 claims within the last three years) have resulted from accidents that occurred along the route, the system may determine to increase the deductible from $500 to $510.

As another example, an adjustment determination at step 325 for a current trip may include using insurance information indicating that the current driver has previously submitted a claim as a result of an accident on the same route that is being taken for the current trip to determine that the deductible should be increased from $500 to $525. In comparison, if the same insurance information were to indicate that the driver has previously submitted two claims as a result of being in two accidents on the same route that is being taken for the current trip, the system may determine to adjust the deductible from $500 to $600. In contrast, if the same insurance information were to indicate that the current driver has never submitted a claim for an accident on the same route that is being taken for the current trip, the system may determine to decrease the deductible from $500 to $450.

As yet another example, an adjustment determination for a current trip may include using insurance information indicating that drivers similar to the current driver (e.g., similar in age, gender, interests, geographical location, etc.) have previously submitted twenty (20) claims as a result of accidents on the same route that is being taken for the current trip to determine that the deductible should be increased from $750 to $800. In comparison, if the same insurance information were to indicate that other similar drivers (e.g., drivers of similar type) have previously submitted one hundred (100) claims as a result of accidents on the same route that is being taken for the current trip, the system may determine to adjust the deductible from $750 to $1,000. In contrast, if the same insurance information were to indicate that the other similar drivers have only submitted three (3) claims for accidents occurring on the same route that is being taken for the current trip, the system may determine to decrease the deductible from $750 to $500.

After determining the adjustment to the deductible at step 325, an adjustment notification may be output to the user (e.g., driver, policy holder, owner, etc.) of the vehicle. In some cases, the adjustment notification may notify the user of the full adjusted deductible (e.g., $500) may be output to the user, and in some cases, the adjustment notification may notify the user of the amount of the adjustment (e.g., −$100 or +$100). The adjustment notification may be a message displayed on a display of a mobile computing device 100m of the driver, another passenger in the vehicle 202, and/or another policy holder. In some examples, the adjustment notification may be a message displayed on a display of a vehicle computing device 100v of the vehicle 202 being driven. Also, in some examples, the adjustment notification may be an audible message or sound played by a mobile computing device 100m or vehicle computing device 100v so that the driver may be alerted to the adjustment without having to take his/her eyes off the road. Further, in some embodiments where, e.g., the adjustment determination is performed by a deductible determination server 205, step 327 may involve the deductible determination server 205 transmitting the adjusted deductible to a mobile computing device 100m or vehicle computing device 100v so that the adjusted deductible may be output to the driver. Because the adjustments may be output to drivers while they are driving, the adjustment may incentivize or encourage drivers to drive more safely, avoid driving on a dangerous route, change their driving situation (e.g., reduce a noise level in the vehicle, block text messages from being received on their mobile computing devices 100m, etc.), avoid dangerous driving conditions (e.g., stop driving in bad weather or heavy traffic).

In step 329, the adjusted deductible that was determined in step 325 may be recorded. For example, the adjusted deductible may be stored in memory of a deductible determination server 205 or a device connected thereto. In such examples, step 329 may involve a mobile computing device 100m transmitting the adjusted deductible to a deductible determination server 205 so that the adjusted deductible may be recorded. The adjusted deductible may also be stored in memory of a mobile computing device 100m or vehicle computing device 100v. The adjusted deductible may be stored in association with a time. The time may represent a time at which the adjusted deductible becomes effective. Recording of the adjusted deductible in step 329 may be similar to the recording of the deductible in step 315, and thus, further description of step 329 is not given here.

In step 331, the system determines whether the trip has ended. A user (e.g., driver or passenger) may indicate the end of a trip by selecting an option (e.g., button or key) on a mobile computing device 100m or vehicle computing device 100v. In some examples, the end of the trip may be recognized (automatically) by the system based on an analysis of, for example, location information or speed information. If the location of the vehicle 202 has not changed or the speed of the vehicle 202 has remained below a predetermined threshold for some predetermined amount of time, the system may determine that the trip has ended. The system may also determine that the trip has ended if the driver does not respond to a prompt, output from the mobile computing device 100m or vehicle computing device 100v, to the user regarding whether the trip has ended. Such a prompt may include an audible message or displayed message to the user (e.g., driver or passenger).

If it is determined that the trip has ended (Yes at step 331), the process may end. If it is determined that the trip has not ended (No at step 331), step 333 may be performed. In step 333, the system may determine whether an accident has occurred during the trip. In some embodiments, the system may automatically determine that an accident has occurred. For example, vehicle sensors (e.g., airbag sensors) may detect the accident and send a signal to the mobile computing device 100m of the driver informing the system that an accident has occurred. In some examples, the user (e.g., driver) may select an option (e.g., button or key) on a mobile computing device 100m or vehicle computing device 100v to indicate that an accident has occurred.

If the user is involved in an accident during the trip, the user may submit an insurance claim at step 335. In some examples, submission of the claim may simply involve a user indicating that an accident has occurred. In some examples, the claim may be automatically submitted upon automatic detection of the accident. When submitting a claim, some information about the claim may be automatically captured by the system and include in the claim submission. For example, the mobile computing device 100m through which the claim is submitted may automatically retrieve GPS coordinates for inclusion with the claim submission. Accordingly, the device receiving the claim submission (which may be a deductible determination server 205 or other device of the same entity, such as an insurance company, that manages the deductible determination servers 205) may record a location in association with the claim. Moreover, in some examples, the user (e.g., driver or passenger) may enter other information, such as a description of another vehicle or the damage sustained, as part of the claim submission.

The claim submitted in step 335 may also include data indicating the deductible at the time of the accident. For example, the mobile computing device 100m may determine the most recently determined deductible adjustment and include that adjustment with the claim submission. In this manner, the claim may include the deductible that was in effect at the time of the accident.

In step 337, the system may execute a wait period. The wait period may be executed so that the deductible determination is not repeated excessively. For example, it might not be desirable to repeat the deductible determination every millisecond because such determinations may be computationally expensive (e.g., CPU intensive), and therefore, may take up processing power of a device that could otherwise be used to perform other processes and/or may drain a battery of a device. Such considerations may be of particular concern in embodiments where the deductible determination is performed by a mobile computing device 100m. Accordingly, the deductible determination system may implement a wait period of, for example, one minute. After the wait period, the system may repeat step 321 to determine the current driving situation again, and then subsequently may determine another deductible adjustment. As such, the current driving situation may be evaluated multiple times during a trip and the deductible may be adjusted multiple times during the trip in accordance with changes in the current driving situation.

It should be understood that the method of FIG. 3 is an example and that other methods with similar steps are contemplated. In such other methods, additional steps may be included or steps may be omitted. Also, other methods may change the order of any of the steps. For example, step 325 may be performed before step 323 such that the system determines what the adjusted deductible would be before determining whether to effectuate the adjustment.

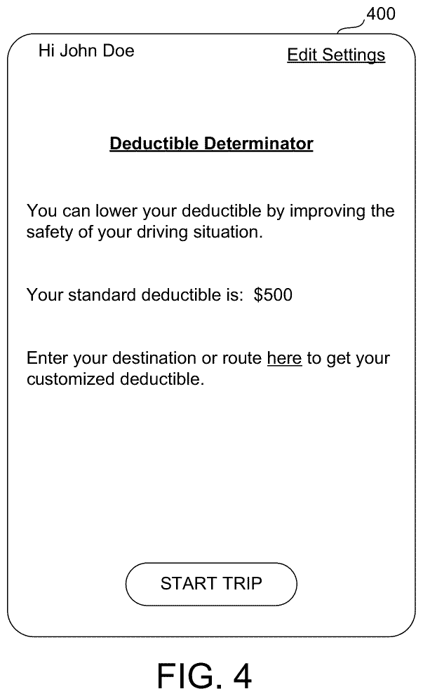

FIGS. 4-6 illustrate example user interfaces in accordance with aspects of the present disclosure. These interfaces may be displayed on a screen of a mobile computing device 100m (e.g., a smartphone) or vehicle computing device 100v before, during, or after a trip. These interfaces may be generated by a client-side deductible determination program. Data for generating these interfaces may be provided as a push notification from a server (e.g., deductible determination server 205 or service provider server 204) or as a message (e.g., short message system (SMS) message or multimedia message system (MMS) message). It should be understood that the interfaces 400-600 of FIGS. 4-6 are intended to illustrate various features and aspects of the deductible determination system, and that interfaces are not limited to the visual appearance or layouts depicted in FIGS. 4-6.

The interface 400 may be displayed before a user has begun driving. As shown in FIG. 4, the interface 400 may include a message to the user informing the user that she may lower her deductible by improving the safety of her driving situation. In some examples, a link to a tutorial or other interface may be included to further explain what factors may contribute to the safety of the driving situation and what the user may do to improve the safety of the driving situation. Further, the interface 400 may display the user's standard deductible (e.g., $500) as set forth in the applicable insurance policy. In an aspect of the present disclosure, when a policy holder and insurance company establish an insurance policy, the parties may agree on certain terms which may set the standard deductible and specify that the deductible may increase or decrease depending on a driving situation.

The mobile computing device 100m displaying the user interface 400 may retrieve the standard deductible from the deductible determination server 205 or another device of an insurance company providing the applicable insurance policy. For example, the mobile computing device 100m may transmit identification information (identifying the user/driver, vehicle, insurance policy, mobile phone number, etc.) to a deductible determination server 205 which may respond with the appropriate standard deductible based on the identification information.

FIG. 4 also shows that the interface 400 may include an option (e.g., button or key) for the user to press (or otherwise select) to indicate that a trip is to begin/start. Additionally, or alternatively, voice commands may be used to indicate that the trip is to begin. In some embodiments, the interface 400 may also include a link that allows the user to enter her destination or intended route prior to beginning a trip.

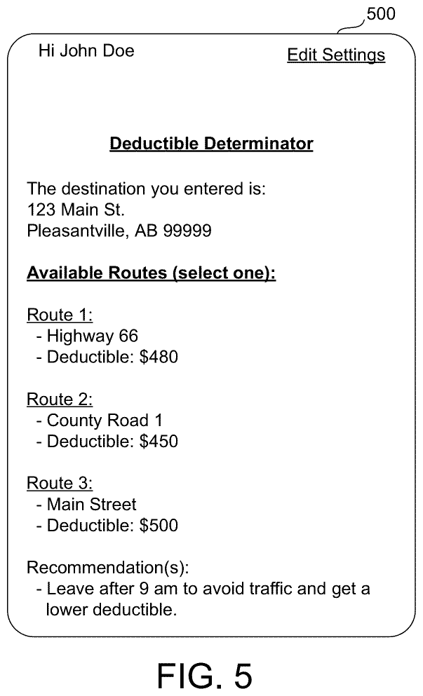

When the link in FIG. 4 for entering a destination or route is selected, another interface may be displayed on the screen of the mobile computing device 100m or vehicle computing device 100v. FIG. 5 illustrates an example interface 500 displayed in response to selection of such a link. As show in FIG. 5, the user may enter a destination for a trip that is about to begin and the system may determine one or more routes (if available multiple routes may be determined). The one or more available routes may be output (e.g., displayed) to the user to allow the user to select which route she wishes to take. For each route, the system may determine and provide a deductible that would apply. Such deductibles may be based on the level of safety of the particular route. The deductibles may be lower or higher than the standard deductible.

As shown in FIG. 5, the deductible for route 2 may be lower than the deductible for route 1 because route 2 may be deemed safer based on past insurance claim information, past accident information, and/or safety scores calculated for the routes. Also, for example, the deductible for route 2 may be lower than the deductible for route 1 because the traffic, at the time the trip is to be taken, on route 2 may be less than the traffic on route 1.

FIG. 5 further illustrates that the system may provide recommendations. In the example interface 500 of FIG. 5, the recommendation may include a message that a lower deductible may be applied if the trip is delayed until a time when traffic is reduced. Other recommendations may be provided as well. For example, the interface 500 may include a recommendation/suggestion to wait until bad weather ends or visibility improves.

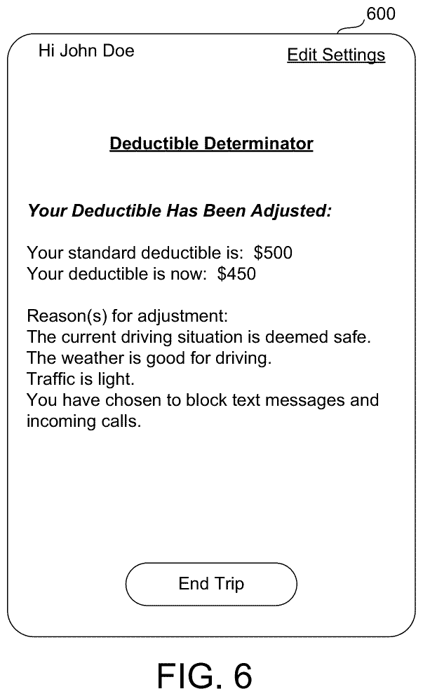

FIG. 6 illustrates an example interface 600 that may be displayed during a trip (e.g., while a vehicle is moving). As shown in FIG. 6, the interface 600 may include a message or alert indicating that the deductible has been adjusted. It should be understood that such a message or alert may be provided to the user as an audio message or other sound, thereby informing the user of the adjustment without requiring the user to view a display. The audio message or other sound may be played through the vehicle's speakers or a speaker of the mobile computing device 100m.

In some examples, the user or driver may be informed of the standard deductible and the new (e.g., current) deductible in effect. In some examples, the user or driver may just be informed that the deductible has been adjusted and/or that the adjustment is up or down. Still, in some examples, the user or driver may be informed of the amount of the deductible adjustment.

Further, in some embodiments, the interface 600 may include one or more reasons that the deductible was adjusted. For example, the interface 600 may include a message indicating that the adjustment was decreased because the current driving situation was deemed safe. Also, the interface 600 may provide more specific reasons for the adjustment. For example, the interface 600 may indicate that the adjustment was applied because of the weather (e.g., because it is sunny), traffic (e.g., because it is light), and/or a driver's choice to block text messages and phone calls from being received or transmitted.

FIG. 6 also illustrates that the interface 600 may include an option (e.g., button or key) for the user to press (or otherwise select) to indicate that a trip has ended. Additionally, or alternatively, the user may provide voice commands to indicate that the trip has ended. The user/driver may indicate that the trip has ended so that the deductible determination system stops evaluation the current driving situation and stops adjusting the deductible until a future trip.

Further, the interfaces 400-600 also illustrate that an option to change settings may be provided. For example, the user/driver may change settings related to whether they are notified of deductible adjustments and how often they are notified of deductible adjustments. The settings may also be used to turn on/off an ability to receive or send text messages or phone calls. In some embodiments, the settings may be used to modify terms or information of an insurance policy, including changing the standard deductible.

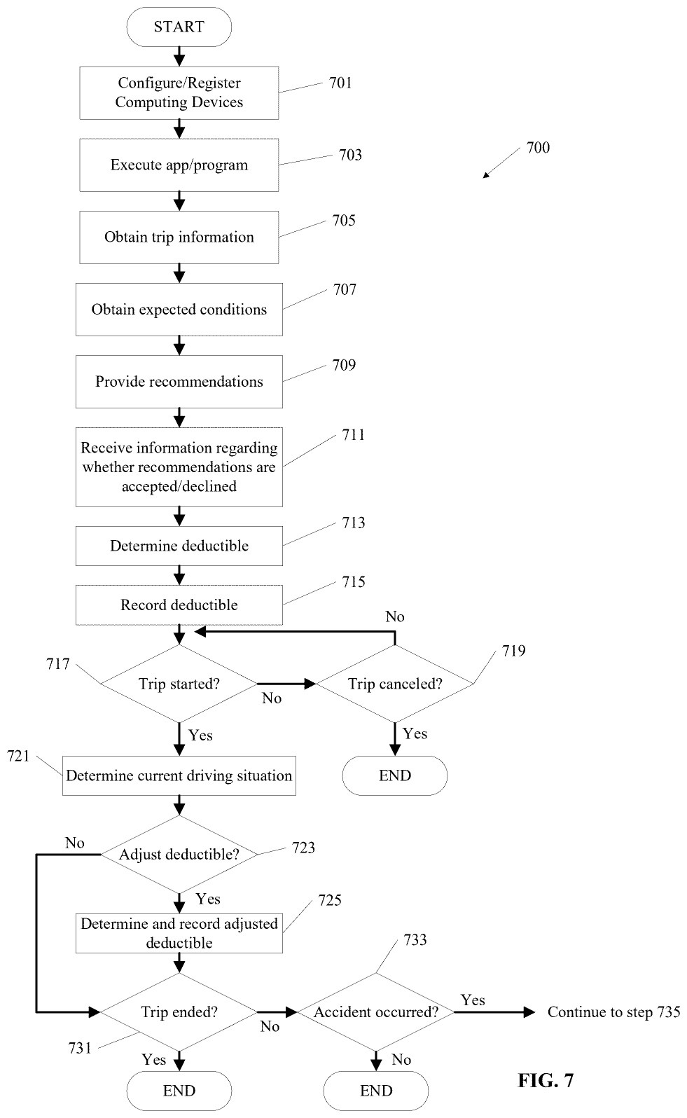

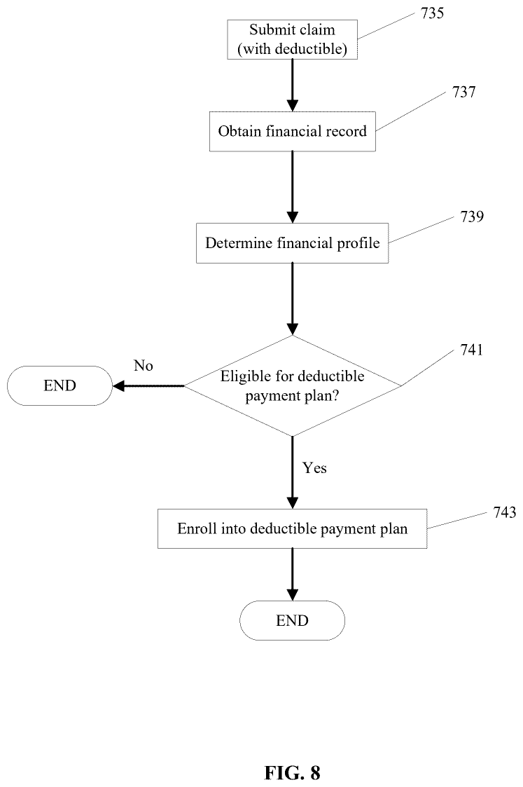

FIGS. 7 and 8 illustrate a flow diagram for an example process 700 in accordance with aspects of the present disclosure. More specifically, FIGS. 7 and 8 illustrate a plurality of steps of a method for determining eligibility for a deductible payment plan that may be based on the adjusted deductible, the current driving situation, and/or a financial record. In some embodiments, the method for determining eligibility for the deductible payment plan may be based on a driver's score or safety score, and/or a financial profile determined from a user's financial record as described in more detail below. Some or all of the steps of process 700 may be performed with the process described with respect to FIG. 3 as described above. Further, the process 700 described in FIGS. 7 and 8 are described in a particular order for illustrative purposes only, and some or all the steps of process 700 may be applied in any order without departing from the scope of the disclosure.

The steps of FIGS. 7 and 8 may be performed by various devices disclosed herein, and in particular the mobile computing device 100m, such as a cell phone of a driver of the vehicle 202, the vehicle computing device 100v, or the deductible determination server 205. Herein, where the system is described as performing a step or process, it should be understood that any device in the system may perform the step or process alone or in conjunction with another device of the system (or another device connected thereto). One or more of the steps of FIGS. 7 and 8 may be performed by executing a client-side deductible determination system, a server-side deductible determination system, and/or operating a particularly configured computing device of the deductible determination system.

As a result of the method of FIGS. 7 and 8, the deductible determination system may determine a deductible payment plan and output to a user (or driver of a vehicle). Users may be incentivized or encouraged to improve their driving situation to receive a desirable deductible. In an event of an accident, in some embodiments, users of the method of FIGS. 7 and 8 may have a good driving record (e.g., low number of accidents or no accidents) and a desirable recommendation from the user's financial profile (e.g., one or more attributes of the financial profile indicate the user will be likely to repay the deductible, one or more monetary assets above a monetary threshold, history of making on-time loan payments or early loan payments) to receive a deductible payment plan. An accident can happen unexpectedly and may be a difficult problem to solve for the driver of the vehicle. To reduce the driver's concerns with addressing the vehicle accident, the driver may enroll into a deductible payment plan to spread out the deductible over a predetermined time period (e.g., weeks, months, or years). Further, performance of the method of FIGS. 7 and 8 may allow users increased flexibility in deductible payments, which may lead to increased customer satisfaction, which in turn may lead to customer loyalty and customer retention.

The method of FIGS. 7 and 8 may begin with step 701 of configuring and/or registering the computing devices (e.g., mobile computing device 100m, vehicle computing device 100v) of the deductible determination system. For example, configuring a mobile computing device 100m of a customer of an insurance company may include downloading and installing a deductible determination program (e.g., a client-side deductible determination program). Different mobile computing devices 100m and vehicle computing devices 100v may install different versions of the deductible determination program depending on a platform of the mobile computing device 100m or vehicle computing device 100v. For example, a mobile computing device running the iOSTM™ operating system may download a different version of the deductible determination program than a device running the ANDROID™ operating system.

Step 701 may also include registering a computing device (e.g., mobile computing device 100m or vehicle computing device 100v) with the organization (e.g., an insurance company) providing the deductible determination system. Registering a computing device may include creating and/or logging into an account with an associated username and/or password. The account may be associated with the mobile computing device 100m and/or an insurance policy of a user of the mobile computing device 100m. To perform registration, the organization providing the insurance company may request various information, including information regarding a user device (e.g., device identifier, device make, device model, etc.), information regarding a user (e.g., name, birthdate, address, insurance policy number, etc.), and/or information regarding a vehicle (e.g., make, model, year, vehicle identification number (VIN), etc.). Registration may also include setting up an account for maintaining a record of deductible adjustments.

In some embodiments, when registering with the deductible determination system, a user may create a profile. The profile may include certain user preferences so that a customized experience may be realized.

In step 703, the client-side deductible determination program installed on the mobile computing device 100m may be executed. Where the client-side deductible determination program is an “app” on a smartphone, step 703 may include a user selecting the “app” and the operating system of the smartphone running the “app.” The client-side deductible determination program may run continuously in the background of the mobile computing device 100m so that it is configured to adjust deductibles whenever a user is driving. In other words, the deductible determination program may run in the background of the mobile computing device 100m continuously so that users do not have to interact with the program each time they are about to begin a drive or end a drive. Because the client-side deductible determination program may run in the background it might not be distracting to users wishing to perform other operations with their mobile computing devices 100m, and therefore, users may be more likely to adopt the client-side deductible determination program. In some embodiments, once launched, the client-side deductible determination program may be launched automatically each time the mobile computing device 100m is powered on. Thus, if the mobile computing device 100m is turned off or its battery dies, the client-side deductible determination program may be automatically launched again when the mobile computing device 100m is turned back on or powered back up.

In some embodiments, the client-side deductible determination program may enter a sleep mode so as not to drain the battery of the mobile computing device 100m when the user is not driving. For example, in some embodiments, the client-side deductible determination may remain in a sleep mode to conserve battery power until a user begins driving.

In step 705, a mobile computing device 100m (e.g., using the client-side deductible determination program), a vehicle computing device 100v, a deductible determination server 205 (by way of a mobile computing device 100m or vehicle computing device 100v), or other device of the deductible determination system may obtain trip information. Step 705 may include obtaining route information indicating a route to be taken for an upcoming trip or trip currently underway. Step 705 may also include obtaining destination information indicating a destination for an upcoming trip or trip currently underway. Other trip information, such as a number of passengers, names of passengers, vehicle information indicating a make, model, year, etc. of a vehicle to be driven on a trip, and driver information indicating a name of a driver, may also be obtained at step 705.

Step 707 may include obtaining expected conditions for the trip. For example, weather conditions or road conditions that may be encountered on the trip may be obtained. These conditions may be obtained from information provided by third party servers 203. Such conditions may be based on the route information or destination information obtained in step 705. For example, using the destination of the trip, weather conditions that may be encountered along the way to the destination may be obtained. Also, for example, using route information indicating the route of the trip, information regarding road conditions of roads forming the route may be obtained.

In some embodiments, step 707 may include obtaining information regarding the vehicle 202 to be used for the trip. This information may be obtained from, for example, the vehicle computing device 100v (including, e.g., vehicle sensors). Examples of this information may include that tire pressure of the vehicle 202 is low, brake fluid of the vehicle 202 is low, brakes of the vehicle 202 are old or worn out (which may be determined based on number of miles driven and when the brakes were last replaced), windshield wipers of the vehicle 202 are old or worn out (which may be determined based on an amount of total time or number of times they have been used), or that the vehicle 202 otherwise needs maintenance.

In step 709, the deductible determination system may determine and provide recommendations to the driver of the trip. For example, the system may recommend that another driver (e.g., the wife of the intended driver, another colleague of the intended driver, etc.) be the driver for the trip. Also, the system may recommend that a different route be taken for the trip. For example, the system may determine that another route is safer and may recommend that the user take the other route for the trip. Other recommendations may include postponing the trip until the weather changes (e.g., until it stops raining) or making the trip at a different time (e.g., either earlier or later) so that the trip takes place at a time when there is less traffic (e.g., non-rush hour times) or better visibility (e.g., during the day instead of at night).

In some embodiments, an amount of an adjustment of a deductible or the new adjusted deductible that would be received if the recommendation is accepted may be provided in step 709 as well. For example, the mobile computing device 100m may display a message on its screen recommending that the user take a safer route different from the one intended and indicating that if the user takes the safer route their deductible may be decreased by $100. When providing recommendations in step 709, the system may also prompt the user whether they wish to accept or decline the recommendations.

Step 711 may include receiving information regarding whether a user accepted or declined one or more recommendations. It should be understood that a user may accept one recommendation and decline another recommendation. Accepting or declining a recommendation may be performed by a user by pressing a button or key on the mobile computing device 101m or vehicle computing device 100v (which may include, e.g., a display mounted on the dashboard of a vehicle 202).

In step 713, based on the expected conditions and information regarding whether recommendations were accepted or declined, the deductible determination system may determine a deductible for the trip. In some embodiments, at step 713, the deductible determination system may determine a deductible at the initial purchase or signup of the insurance policy. Acceptance of recommendations may result in lower deductibles. Moreover, in some examples, acceptance of a recommendation may result in a lower deductible than if the user had planned to take the recommended course of action in the first place. For example, the user's deductible may be lower in a case where the user selects a first route but then accepts a recommendation to take a second route (e.g., a safer route) than if the user were to have selected the second route from the start. Thus, the user may be especially rewarded for accepting recommendations. In some embodiments, the deductible may be output to the user (e.g., driver of the trip) at step 713 as well.

In step 715, the adjusted deductible may be recorded in memory (such as memory of a mobile computing device 100m, vehicle computing device 100v, deductible determination server 205, or any other device of the deductible determination system or any other memory of any computing device in communication with the system). The newly adjusted deductible or an amount of adjustment from a base deductible (e.g., the base deductible set in an insurance policy) may be recorded. A time may also be stored in association with the adjusted deductible. The time may represent a time at which the adjusted deductible becomes effective. If the vehicle is involved in an accident, the deductible in effect at the time of the accident may be the deductible used to determine what the policy holder is responsible for and what the insurance company is responsible for. The adjusted deductible may remain in effect until a new adjusted deductible is determined or for a predetermined time after it becomes effective (in the latter case, the deductible may revert back to the base deductible or some other deductible upon expiration of the predetermined time).

In some embodiments, the time recorded in step 715 may correspond to the time that the adjusted deductible was determined or a predefined time thereafter (e.g., 1 minute after the determination is made). In some embodiments, where the adjusted deductible is determined by a deductible determination server 205, the time may correspond to the time that the adjusted deductible was transmitted to the mobile computing device 100m or vehicle computing device 100v. In some embodiments, the time may correspond to the time that the adjusted deductible was output to the user. For example, the time may be a time that the mobile computing device 100m or vehicle computing device 100v displayed the adjusted deductible or played an audio message indicating the adjusted deductible.

In step 717, the system may determine whether a trip has started. This determination may be made based on an input from a user indicating the start of a trip. Additionally, or alternatively, this determination may be made based on automatically acquired information, such as information indicating whether a vehicle 202 is running or information indicating that the vehicle is moving (which may be assumed based on the mobile computing device 100m traveling above a certain speed).

If the deductible determination system determines that the trip has not started (No at step 717), the system may determine whether the trip has been canceled at step 719. In step 719, the system detects whether the trip has been canceled based on manual information and/or automatic information. For example, the user may indicate that the trip is canceled by pressing a button or key on a mobile computing device 100m or vehicle computing device 100v. The system may also assume the trip is canceled if the vehicle 202 is not turned on or moved within a certain period of time from, for example, execution of the client-side deductible determination program at step 703 or determination of the deductible at step 713.

If the trip is canceled (Yes at step 719), the process may end. Of course, the process may be repeated again in the future when the user goes to take another trip. It should be understood that the process of FIGS. 7 and 8 may be performed multiple times as a user may make multiple driving trips.

If it is determined that the trip is not canceled (No at step 719), the system may repeat step 717. Effectively, the system may wait until it determines whether the trip is started or canceled.

Once it is determined that the trip has started (Yes at step 717), the deductible determination system may determine a current driving situation at step 721. Herein, a current driving situation may be a situation that the vehicle is in during a particular trip. The deductible determination system may select one or more of various factors for determining the current driving situation. Example factors include weather conditions (e.g., whether it is sunny, cloudy, rainy, etc.) at the vehicle's current location (or in proximity, e.g., within a mile, five miles, etc., of the vehicle), road conditions (e.g., slippery, road work in progress, etc.) the vehicle may encounter, traffic conditions (e.g., heavy, medium, light, etc.) at the vehicle's current location, type of roads (e.g., highways, one way street, street with medium, residential street, etc.) the vehicle is travelling on, conditions inside a vehicle 202 (e.g., noisy, distractions, etc.), conditions outside of the vehicle 202 but in the vehicle's proximity (e.g., towing a boat or trailer, tailgating, etc.), conditions of the vehicle 202 itself (e.g., needs maintenance), conditions of the driver (e.g., whether the driver sleepy, intoxicated, etc.) which may be captured using a camera or other sensor (e.g., breathalyzer), choices a driver makes (e.g., whether to allow text messages or phone calls), driving behavior (e.g., hard braking events, speeding, hard acceleration, hard turning, etc.), number of passengers in the vehicle 202, accident history at the current location (e.g., the driver's accident history, general public's accident history, or accident history of an entity's customers such as the accident history of an insurance company's customers), insurance company claims associated with the current location (e.g., number of insurance claims made for accidents occurring at the current location, damage claimed in insurance claims at the current location), traffic lane (e.g., left lane, middle lane, right lane, etc.), and time of day (e.g., 8 am or between 3 pm and 5 pm).

In some embodiments, factors not specific to the current driving situation may also be selected for consideration in determining the deductible. For example, the driver's age, gender, eyesight, etc. may be selected. In some embodiments, the factors selected may vary. The factors selected may depend on the driver or insurance policy. Certain factors may be considered for one driver, but not another. The factors selected may also depend on how long a driver has been a customer of an insurance company (e.g., how long an insurance policy has been active). Also, the factors selected may depend on what information is available at a time of making the determination. Moreover, factors selected may depend on other factors. For example, if weather conditions are good and/or it is during the daytime, the system might not consider the type of roads.

Once the factors to consider have been selected, the deductible determination system may obtain information associated with the selected factors. For example, if the system selects to consider traffic information, the system may poll a third party server 203 to obtain traffic information. Specifically, the system may send the third party server 203 a current location (e.g., GPS coordinates) of the vehicle 202 and receive traffic information (e.g., whether the traffic in the current location is light, medium, heavy, very heavy, etc.) in return.

The information for the selected factors may come from various sources depending on what information is being sought. Sources may include any of the computing devices in the deductible determination system, including one or more third party servers 203, one or more service provider servers 204, one or more deductible determination servers 205, the mobile computing device 100m, the vehicle computing device 100v, the OBD device 206, etc. For example, information on whether the user has chosen to block text messages or phone calls may come from the mobile computing device 100m or service provider server 204. Information on whether the vehicle 202 is currently speeding may come from the vehicle computing device 100v or OBD device 206. Information on a number of insurance claims or total amount of damage claimed associated with the current location of the vehicle 202 may be retrieved from one or more deductible determination servers 205 or one or more databases (e.g., computing devices of an insurance company) connected thereto.

In some embodiments, the deductible determination system may convert (or translate) the obtained information for each selected factor into a standard format or score (e.g., value). In some cases, the deductible determination system may determine a value for each piece of obtained information. For example, the system may convert information that the current traffic is light into a score of “1” and convert information that the current traffic is heavy into a score of “5.” Also, the system may, for example, set a certain variable (e.g., a Boolean variable) that is designated for factoring in whether it is raining to have a certain value (e.g., a value of “true”) if the obtained weather information indicates that it is indeed raining where the driver is driving. Converting or translating the obtained information may assist the system in considering a plurality of different types of information in a single determination of the current driving situation. The obtained information in its raw form might not be suitable for use in determining the current driving situation, and thus, it may be necessary to first convert the raw information.

The obtained information or converted information may be used in an algorithm for determining (or computing) a safety score (or level of safety). In some embodiments, different algorithms may be available and the system may choose which algorithm to use. The algorithm may be selected based on the type of driver or the insurance policy of the driver.

Further, step 721 may include selecting weights used by the algorithm to weigh the obtained information or converted information appropriately. A weight may be a coefficient for a variable designated for a particular type of condition. Different conditions may be weighted differently. For example, weather conditions may be weighted more heavily than traffic conditions, which may be weighted more heavily than a noise level inside the vehicle 202.

Using any determined weights and the obtained information (in either its raw or converted form), an algorithm for determining the safety score for the current driving situation may be executed. Execution of the algorithm may result in a numeric value that may represent a safety score for the current driving situation. In some cases, this safety score may be on a scale of 1 to 100, 1 to 5, or any other scale.

In step 723, the deductible determination system may determine whether to adjust the deductible. This determination may be based on the safety score determined in step 721. For example, the deductible determination system may determine to adjust the deductible if the safety score is above a threshold, below a threshold, or has changed by a certain amount from a previously calculated safety score for the same trip. For example, if the safety score exceeds an 80 out of 100, the system may determine to adjust the deductible, whereas a safety score of 75 might not trigger the system to adjust the deductible. Additionally, or alternatively, if the safety score has changed (e.g., increased or decreased) by a predefined threshold (e.g., 5 points) from a safety score previously determined during the same trip, the system may determine to adjust the deductible. The thresholds described herein may differ for different trips or different drivers. By including this step of determining whether to adjust a deductible, the process may regulate how often deductibles are adjusted. In some cases, it might not be desirable to frequently adjust the deductible because frequent adjustments may, for example, distract the driver.

If the system determines not to adjust the deductible (No at step 723), the system may proceed to step 731 to determine whether the trip has ended as described in further detail below. It should be understood that the system may repeat steps 721 and 723 multiple times during a single trip.

If the system determines to adjust the deductible (Yes at step 723), the system may determine the adjustment at step 725. Determining the adjustment to the deductible may include determining a new deductible or determining an amount by which to change a policy holder's current deductible (which may be the standard deductible or a recently adjusted deductible). Step 725 may include obtaining the standard deductible set forth in an insurance policy or the most recently adjusted deductible. The adjustment to the deductible for the current trip may be determined using the safety score. The deductible adjustment for the current trip may also be determined using information regarding past accidents or past insurance claims for (a) the current route or road being taken for the current trip, (b) the type of driver or driving history/record of the current driver, and/or (c) the current driving situation (which may be represented by the safety score).

The information regarding past accidents (e.g., vehicle collisions involving multiple vehicles, vehicle crashes, and other moving vehicle accidents) may indicate a type of accident (e.g., vehicle collision, vehicle crash, etc.), the driver(s) involved in the accident, the party responsible for the accident, the vehicle(s) involved in the accident, condition(s) at the time of the accident, and a location of the accident. This information may be stored in association with each other for each accident and this information may exist for a plurality of accidents so that a significant amount of information is available for adjusting deductibles.

The information regarding past insurance claims (e.g., automotive insurance claims) may indicate a policy holder who submitted the claim, an amount of damage claimed, a reason or event (e.g., accident, theft, vandalism, natural disaster, etc.) that led to the insurance claim being issued, a location of the event that led to the insurance claim being issued, a date and/or time of the event that led to the insurance claim being issued, a weather condition (or any other condition) during the event that led to the insurance claim being issued, a party/entity responsible for the event that resulted in the damage, the driver if the claim relates to a moving vehicle accident, etc. This information may be stored in association with each other for each claim and this information may exist for a plurality of claims so that a significant amount of information is available for adjusting deductibles.

The information regarding past accidents or past insurance claims may be obtained from the deductible determination servers 205 and/or one or more databases (or other devices) connected thereto. Also, information regarding past accidents may be extracted from information regarding past insurance claims. As discussed, insurance claim information may indicate a reason or event (e.g., accident, theft, vandalism, natural disaster, etc.) that led to the insurance claim being issued. Thus, accident information may be collected (or extracted) from such insurance information.

Examples of adjustment determinations that may be made by the deductible determination system using, e.g., a deductible controller 101 (which may use e.g., a deductible determination program) may be similar to the examples described in step 325 as shown in the process of FIG. 3.

With continued reference FIG. 7, in step 725, the determined adjusted deductible may be recorded. For example, the adjusted deductible may be stored in memory of a deductible determination server 205 or a device connected thereto. In such examples, step 725 may involve a mobile computing device 100m transmitting the adjusted deductible to a deductible determination server 205 so that the adjusted deductible may be recorded. The adjusted deductible may also be stored in memory of a mobile computing device 100m or vehicle computing device 100v. The adjusted deductible may be stored in association with a time. The time may represent a time at which the adjusted deductible becomes effective. Recording of the adjusted deductible in step 729 may be similar to the recording of the deductible in step 715, and thus, further description of step 729 is not given here.

In step 731, the system determines whether the trip has ended. A user (e.g., driver or passenger) may indicate the end of a trip by selecting an option (e.g., button or key) on a mobile computing device 100m or vehicle computing device 100v. In some examples, the end of the trip may be recognized (automatically) by the system based on an analysis of, for example, location information or speed information. If the location of the vehicle 202 has not changed or the speed of the vehicle 202 has remained below a predetermined threshold for some predetermined amount of time, the system may determine that the trip has ended. The system may also determine that the trip has ended if the driver does not respond to a prompt, output from the mobile computing device 100m or vehicle computing device 100v, to the user regarding whether the trip has ended. Such a prompt may include an audible message or displayed message to the user (e.g., driver or passenger).

If it is determined that the trip has ended (Yes at step 731), the process may end. If it is determined that the trip has not ended (No at step 731), step 733 may be performed. In step 733, the system may determine whether an accident has occurred during the trip. In some embodiments, the system may automatically determine that an accident has occurred. For example, vehicle sensors (e.g., airbag sensors) may detect the accident and send a signal to the mobile computing device 100m of the driver informing the system that an accident has occurred. In some examples, the user (e.g., driver) may select an option (e.g., button or key) on a mobile computing device 100m or vehicle computing device 100v to indicate that an accident has occurred.

As shown in FIG. 8, if the user is involved in an accident during the trip, the user may submit an insurance claim at step 735. In some examples, submission of the claim may simply involve a user indicating that an accident has occurred. In some examples, the claim may be automatically submitted upon automatic detection of the accident. When submitting a claim, some information about the claim may be automatically captured by the system and include in the claim submission. For example, the mobile computing device 100m through which the claim is submitted may automatically retrieve GPS coordinates for inclusion with the claim submission. Accordingly, the device receiving the claim submission (which may be a deductible determination server 205 or other device of the same entity, such as an insurance company, that manages the deductible determination servers 205) may record a location in association with the claim. Moreover, in some examples, the user (e.g., driver or passenger) may enter other information, such as a description of another vehicle or the damage sustained, as part of the claim submission.

The claim submitted in step 735 may also include data indicating the deductible at the time of the accident. For example, the mobile computing device 100m may determine the most recently determined deductible adjustment and include that adjustment with the claim submission. In some embodiments, the deductible may not include any adjustments before the time of the accident (i.e., No at step 723). In this manner, the claim may include the deductible that was in effect at the time of the accident.

With continued reference to FIG. 8, at step 737, the system may obtain financial information including a financial record associated with the user. In some embodiments, the financial record may be obtained from the deductible determination server 205 or other servers in communication with the deductible determination server 205 such as servers from financial institutions. The financial record may include monetary assets or evaluation of the user's monetary assets. Monetary assets may include type of accounts such as bank or retirement accounts, credit history, FICO, and/or data associated with loan payments (e.g., home or auto loans). In some embodiments, the data associated with loan payments may include history of on-time payments and/or paying off one or more loans early. The system may obtain other monetary asset information in other embodiments.

In step 739, the system may determine a financial profile based on the financial record. The financial profile may include one or more attributes associated with the obtained financial record. The obtained financial record may be used in an algorithm for determining (or computing) the financial profile. In some embodiments, different algorithms may be available and the system may choose which algorithm to use. The algorithm may be selected based on one or more attributes such as the type of financial information, type of monetary assets, number of monetary assets, credit history, FICO score, history of loan payments, history of payment options for bills such as autopay or non-autopay, and/or any combination thereof. In some embodiments, the obtained financial record may be used in a machine learning model for determining the financial profile. In some embodiments, the machine learning model may be trained on historical financial records and/or financial profiles associated with other users to predict financial profiles for future users.

Further, in step 739, the system may include selecting weights used by the algorithm to weigh the financial profile appropriately. A weight may be a coefficient for a variable designated for a particular type of attribute. The one or more attributes of the financial profile may be weighted differently. For example, current monetary values in bank accounts may be weighted more heavily than history of loan payments. For example, history of loan payments may be weighted more heavily than monetary values in bank accounts. For example, the user's credit history may be weighted more heavily than current monetary values in monetary accounts and/or history of loan payments. For example, the user's history of payment options for bills such as autopay or non-autopay may be weighted more heavily than other attributes of the financial profile. For example, one or more attributes of the financial profile may be weighted more heavily than other attributes of the financial profile.

In some embodiments, in step 739, the system may determine a financial rating from the financial profile. Using any determined weights and the obtained financial information, an algorithm for determining the financial rating for the user may be executed. Execution of the algorithm may result in a numeric value that may represent the financial rating for the user. In some cases, the financial rating may be on a scale of 1 to 100, 1 to 5, or any other scale. In some embodiments, the financial rating may be associated with one or more attributes of the financial profile.

In step 741, the deductible determination system may determine if the user is eligible for a deductible payment plan. In some embodiments, the deductible determination system may determine if the user is eligible for a deductible payment plan at step 713 or step 715. The deductible determination system may use the deductible associated with the user (e.g., policy holder) for determining eligibility for the deductible payment plan. For example, the deductible determination system may use the deductible that was in effect at the time of an event (e.g., accident, theft, vandalism, natural disaster, etc.). For example, the deductible determination system may use an adjusted deductible based on a real time current driving situation (e.g., real time driving conditions). For example, the deductible determination system may use the deductible that was in effect at the time of initial purchase or signup. For example, the deductible determination system may use a deductible determined from a trial period or a particular number of driving trips before the purchase or signup of the deductible. The eligibility for the deductible payment plan may be further based on the financial profile determined in step 739. For example, the deductible determination system may determine eligibility for the deductible payment plan if the deductible determination system determines a desirable user based on the financial profile.

In some embodiments, in step 741, the deductible determination system may determine the user is eligible for a deductible payment plan based on the one or more attributes of the financial profile. The deductible determination system may weigh one or more attributes of the financial profile to determine a desirable user for a deductible payment plan using one or more algorithms. For example, the system may provide a recommendation that the user is eligible for a deductible payment plan based on the one or more weighted attributes of the financial profile. For example, the system may determine one or more attributes of the financial profile that indicate the user may be likely to repay the deductible of the insurance policy. The system may evaluate one or more combinations of the one or more attributes of the financial profile to determine the user is eligible for a deductible payment plan. For example, a combination may include one or more attributes that may be weighted more heavily than the other attributes of the financial profile that indicates the user is eligible for the deductible payment plan.

In some embodiments, the deductible determination system may use the financial rating of the financial profile in part to determine the user is eligible for a deductible payment part. The financial rating may be associated with a monetary value and the threshold may be a monetary threshold. For example, the monetary threshold may be the monetary value of the deductible (e.g., $500 or $1000). In some embodiments, the system may determine the user is eligible for the deductible payment plan if the financial rating is above the monetary threshold (i.e., the user owns monetary assets that cover the deductible).

In some embodiments, the financial rating may be associated with a numerical value and the threshold may be a predetermined numerical score. For example, the threshold may be a predetermined numerical score associated with a credit history or history of paying loan payments. In some embodiments, the system may determine the user is eligible for the deductible payment plan if the financial rating exceeds the predetermined numerical score. For example, if the financial rating exceeds an 80 out of 100, the system may determine eligibility whereas as score of 75 might not trigger the system to determine eligibility for the deductible payment plan. For example, the deductible determination system may determine the user is eligible for the deductible payment plan if the financial rating is above a predetermined numerical threshold associated with a reliable financial record (e.g., monetary assets are higher than the deductible, consistent credit history, high credit score, high FICO score, history of making on-time loan payments, and/or history of paying off loans early).

In step 741, eligibility for the deductible payment plan may further be based on the safety score determined in step 721. For example, the deductible determination system may determine eligibility for the deductible payment plan if the safety score is above a threshold or below a threshold. In some embodiments, the deductible determination system may determine eligibility for the deductible payment plan if one or both of the safety score and the financial rating is above or below a threshold.

For example, the deductible determination system may determine the user is eligible for deductible payment plan if the safety score is above a predetermined numerical threshold associated with high safety (e.g., low number of accidents, no accidents, consistent braking, no mobile device usage during driving, no distracted driving). For example, if the safety score exceeds an 80 out of 100, the deductible determination system may determine eligibility whereas as a score of 75 might not trigger the system to determine eligibility of the deductible payment plan. The thresholds described herein may differ for different trips or different drivers.

Alternatively, in step 741, the system may determine the user is not eligible for the deductible payment plan (i.e., no at step 741). For example, if the safety score is below a threshold, then the system may not approve the user for the deductible payment plan. For example, if the safety score is below a predetermined threshold indicating low safety, then the system may determine the user is not eligible for the deductible payment plan. For example, if one or more attributes of the financial profile indicate the user will not be able to repay the deductible of the insurance policy, then the system may determine the user is not eligible for the deductible payment plan. In some embodiments, if the financial rating of the financial profile is below a threshold, then the system may not approve the user for the deductible payment plan.

After the system determines the user is eligible for the deductible payment plan (i.e., yes at step 731), at step 743, the user may enroll into the deductible payment plan. The system may offer the deductible payment plan immediately at the time of accident, provisionally pending a damage estimation, or after the damage estimation. The system may send an alert or notification to a device (e.g., mobile computing device 100m) connected to the deductible determination system indicating the user is approved for the deductible payment plan. The user may enroll into the deductible payment plan at the time of accident or a time after the accident occurred. The user may enroll into the deductible payment plan using mobile computing device 100m or another device connected in the deductible determination system. The user may make payments over a period of time (e.g., weeks, months, or years) to the deductible payment plan using the mobile computing device 100m or other connected device.

It should be understood that the method of FIGS. 7 and 8 is an example and that other methods with similar steps are contemplated. In such other methods, additional steps may be included or steps may be omitted. Also, other methods may change the order of any of the steps. For example, step 725 may be performed before step 723 such that the system determines what the adjusted deductible would be before determining whether to effectuate the adjustment. In another example, step 739 and step 741 may be performed before step 715 such that the system determines the financial profile and if a user is eligible for the deductible payment plan before recording the deductible. In another example, step 739 and step 741 may be performed before step 731 such that the system determines the financial profile and if a user is eligible for the deductible payment plan after determining an adjusted deductible after a real-time driving situation. In another example, step 737 and step 739 may be omitted such that a determination of whether a user is eligible for a deductible payment plan may be based on the received sensor data.

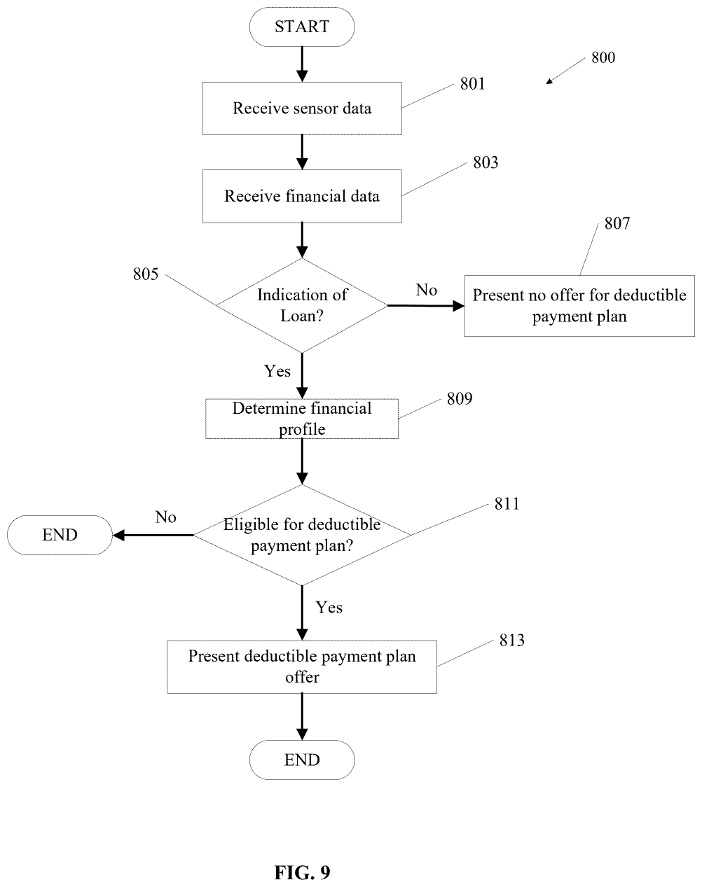

FIG. 9 illustrate a flow diagram for an example process 800 in accordance with aspects of the present disclosure. More specifically, FIG. 9 illustrate a plurality of steps of a method for determining eligibility for a deductible payment plan that may be based on sensor data and/or financial data. In some embodiments, the method for determining eligibility for the deductible payment plan may be based sensor data indicating ownership of property (e.g., home or vehicle) and a financial profile determined from a user's financial data as described in more detail below. Some or all of the steps of process 800 may be performed with the process described with respect to FIG. 3 as described above. Some or all of the steps of process 800 may be performed with process 700 described with respect to FIGS. 7 and 8 as described above. Further, process 800 described in FIG. 9 is described in a particular order for illustrative purposes only, and some or all the steps of process 800 may be applied in any order without departing from the scope of the disclosure.

The steps of FIG. 9 may be performed by various devices disclosed herein, and in particular the mobile computing device 100m, such as a cell phone, the home 210 including the sensors 212, the vehicle 202 including the vehicle computing device 100v, or the deductible determination server 205. Herein, where the system is described as performing a step or process, it should be understood that any device in the system may perform the step or process alone or in conjunction with another device of the system (or another device connected thereto). One or more of the steps of FIG. 9 may be performed by executing a client-side deductible determination system, a server-side deductible determination system, and/or operating a particularly configured computing device of the deductible determination system.

As a result of the method of FIG. 9, the deductible determination system may determine eligibility for a deductible payment plan and output to a user based on sensor data and/or financial data. Users may obtain an insurance policy including a deductible based on ownership of property such as a home or vehicle to help mitigate repair costs in an event of an accident. An accident can happen unexpectedly and may be a difficult problem to solve for the user. In an event of an accident (e.g., auto or home accident), in some embodiments, users of the method of FIG. 9 may enroll into a deductible payment plan to spread out the deductible over a predetermined period of time (e.g., monthly payments) to reduce the user's concerns with addressing the accident. Further, performance of the method of FIG. 9 may allow users increased flexibility in deductible payments, which may lead to increased customer satisfaction which in turn may lead to customer loyalty and customer retention.

Referring to FIG. 9, at step 801, a computing device having at least one processor, a communication interface, and a memory may receive sensor data associated with a user. The computing device may include the deductible determination system. For example, the computing device may receive sensor data from the one or more sensors 212 in communication with the home 210 (FIG. 2). For example, the computing device may receive sensor data from one or more sensors in communication with the vehicle 202. Examples of computing devices in communication with the home 210 having one or more sensors 212 may include connected home devices, smoke detector, thermostat, audio devices, video devices, image devices, electrical meter, water heater, water main to home, air condition unit, smart water devices, smart electrical devices, smart home appliances, home appliances with embedded sensors, and/or smart protection devices. Examples of sensor data may include vehicle telematics data, vehicle ownership, vehicle mileage, vehicle condition including conditions of vehicle parts (e.g., windows, tires, engine, body, etc.), changes in vehicle condition, home ownership, home condition including conditions of home parts (e.g., bedrooms, kitchen, family rooms, dining rooms, garage, backyard, front yard, etc.), auxiliary features associated with the home (e.g., utilities, water, electricity), changes in home condition, and/or any combination thereof. It should be understood that other computing devices including one or more sensors, and other sensor data may be contemplated.

As shown in FIG. 9, at step 803, the computing device may receive financial data associated with the user. In some embodiments, the financial data may be obtained from the deductible determination server 205 or other servers in communication with the deductible determination server 205 such as servers from financial institutions. The financial data may include monetary assets or evaluation of the user's monetary assets. Monetary assets may include bank accounts, types of bank accounts, number of bank accounts, credit report, FICO score, and/or data associated with loan payments (e.g., home or auto loans). In some embodiments, the data associated with loan payments may include history of on-time payments and/or paying off one or more loans early. The computing device may obtain other monetary asset information in other embodiments.

At step 805, the computing device may determine if the user has a loan. For example, computing device may determine the user has a home loan or auto loan based on the financial data indicating a credit report. Further, at step 805, the computing device may determine if the user has an insurance policy including a premium and a deductible. The insurance policy may be for a home or a vehicle. The computing device may determine the deductible at the time of initial purchase or signup of the policy, and/or deductible after the occurrence of an event. At step 807, if the computing device determines no indication of a loan in the financial data (i.e., no at step 807), the computing device presents no offer for a deductible payment plan.

If the computing device determines the user has a loan represented in the financial data (i.e., yes at step 805), at step 809, the computing device may determine a financial profile based on the financial data. The obtained financial data may be used in an algorithm for determining the financial profile. In some embodiments, different algorithms may be available and the system may choose which algorithm to use. The algorithm may be selected based on one or more attributes (or factors) such as the type of financial information, monetary assets, type of monetary assets, number of monetary assets, credit history, FICO score, history of loan payments, history of payment options for bills such as autopay or non-autopay, and/or any combination thereof. In some embodiments, the obtained financial record may be used in a machine learning model for determining the financial profile. In some embodiments, the machine learning model may be trained on historical financial records and/or financial profiles associated with other users to predict financial profiles for future users. The determination of the financial profile at step 809 may similar to step 739 of process 700 described with respect to FIG. 8 described above.

At step 811, the computing device may determine if the user is eligible for a deductible payment plan. The computing device may use a deductible, a loan, and a financial profile associated with the user (e.g., policy holder) for determining if the user is eligible for a deductible payment plan. For example, the computing device may use the deductible that was in effect at the time of an event (e.g., accident, theft, vandalism, natural disaster, etc.). For example, the computing device may use an adjusted deductible based on a real-time driving record. For example, the computing device may use the deductible that was in effect at the time of initial purchase or signup. For example, the computing device may use a deductible determined from a trial period or a particular number of driving trips before purchasing or signing up for the deductible. The eligibility for the deductible payment plan may be further based on a presence of a loan and the financial profile determined in step 809. Further, the one or more attributes of the financial profile may be weighted in one or more combinations to determine if the user is eligible for a deductible payment plan. For example, a combination of one or more weighted attributes of the financial profile may indicate the user can repay the deductible of the insurance policy. For example, a combination of weighted attributes of the financial profile may indicate the user has monetary assets that exceed the deductible which indicates the user can repay the deductible of the insurance policy.

In some embodiments, at step 811, the computing device may determine a financial rating of the financial profile. The financial rating may be used in part to determine if the user is eligible for a deductible payment plan. The deductible determination system may determine eligibility for the deductible payment plan if the financial rating is above a threshold or below a threshold. For example, the user may be eligible for deductible payment plan if the financial rating is above a numerical value or monetary value. The thresholds of the financial rating may be similar to the thresholds described in step 741 of process 700 described above.

Alternatively, in step 811, the computing device may determine the user is not eligible for the deductible payment plan (i.e., no at step 811). For example, one or more attributes of the financial profile may indicate the user cannot repay the deductible of the insurance policy. For example, if the financial rating is below a threshold, the computing device may not approve the user for the deductible payment plan.

After the computing device determines the user is eligible for the deductible payment plan (i.e., yes at step 811), at step 813, the computing device may present an offer for a deductible payment plan. The computing device may send an alert or notification to a device (e.g., mobile computing device 100m) connected to the deductible determination system indicating the user is approved for the deductible payment plan. The user may enroll into the deductible payment plan at the time of accident or a time after the accident occurred. The user may enroll into the deductible payment plan using mobile computing device 100m or another device in communication with the deductible determination system. The user may make payments over a period of time (e.g., weeks, months, or years) to the deductible payment plan using the mobile computing device 100m or other devices in communication with the system.

It should be understood that the method of FIG. 9 is an example and that other methods with similar steps are contemplated. In such other methods, additional steps may be included or steps may be omitted. Also, other methods may change the order of any of the steps. For example, step 809 may be performed before step 805 such that the computing device determines the financial profile before determining presence of a loan at step 805. In another example, step 803 and step 809 may be omitted such that a determination of whether a user is eligible for a deductible payment plan may be based on the received sensor data (e.g., step 801).

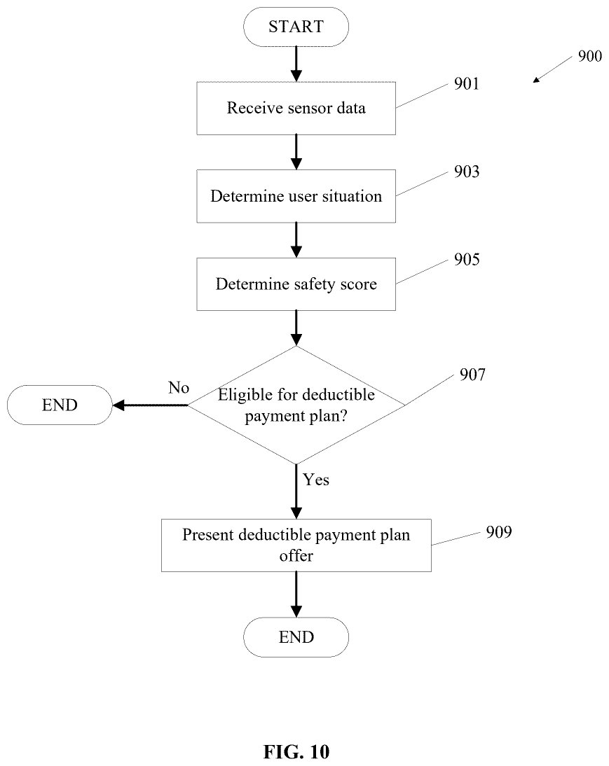

FIG. 10 illustrates a flow diagram for an example method 900 in accordance with aspects of the present disclosure. More specifically, FIG. 10 illustrates a plurality of steps of a method 900 for determining eligibility for a deductible payment plan that may be based on sensor data. In some embodiments, the method 900 for determining eligibility for the deductible payment plan may be based on sensor data indicating ownership of a property (e.g., home or vehicle) as described in more detail below. Some or all of the steps of process 900 may be performed with the process described with respect to FIG. 3 as described above. Some or all of the steps of process 900 may be performed with process 700 described with respect to FIGS. 7 and 8 as described above. Further, process 900 described in FIG. 10 is described in a particular order for illustrative purposes only, and some or all the steps of process 900 may be applied in any order without departing from the scope of the disclosure.

The steps of FIG. 10 may be performed by various devices disclosed herein, and in particular the mobile computing device 100m, such as a cell phone, the home 210 comprising the sensors 212 (or a home computing device comprising sensors 212), the vehicle 202 including the vehicle computing device 100v, or the deductible determination server 205. Herein, where the deductible determination system is described as performing a step or process, it should be understood that any device in the system may perform the step or process alone or in conjunction with another device of the system (or another device connected thereto). One or more of the steps of FIG. 10 may be performed by executing a client-side deductible determination system, a server-side deductible determination system, and/or operating a particularly configured computing device of the deductible determination system.

As a result of the method of FIG. 10, the deductible determination system may determine eligibility for a deductible payment plan and output to a user based on sensor data. Users may obtain an insurance policy including a deductible based on ownership of property such as a home or vehicle to help mitigate repair costs in an event of an accident. An accident can happen unexpectedly and may be a difficult problem to solve for the user. In an event of an accident (e.g., auto or home accident), in some embodiments, users of the method of FIG. 10 may enroll into a deductible payment plan to spread out the deductible over a predetermined period of time (e.g., monthly payments) to reduce the user's concerns with addressing the accident. Further, performance of the method of FIG. 10 may allow users increased flexibility in deductible payments, which may lead to increased customer satisfaction which in turn may lead to customer loyalty and customer retention.

Referring to FIG. 10, at step 901, a computing device having at least one processor, a communication interface, and a memory may receive sensor data from one or more sensors associated with a user. The computing device may include the deductible determination system. The deductible determination system may also be referred to as the system. For example, the computing device may receive sensor data from the one or more sensors 212 associated with the home 210 (FIG. 2) or a home computing device comprising the one or more sensors 212. For example, the computing device may receive sensor data from the vehicle 202 or the vehicle computing device 100v. In another example, the computing device may receive sensor data from the mobile computing device 100m. The sensor data received from the mobile computing device 100m may be processed into mobile device sensor data associated with the user when the user is located in or in proximity to the home 210, and/or mobile device sensor data associated with the user when the user is located in or in proximity to the vehicle 202. In other embodiments, the computing device may receive sensor data from one or more of the sensors 212 associated with the home 210, the home computing device comprising the sensors 212, the vehicle 202, the vehicle computing device 100v, and the mobile computing device 100m.

Examples of computing devices (or home computing devices) associated with the home 210 may include connected home devices, smoke detector, thermostat, audio devices, video devices, image devices, electrical meter, water heater, water main to home, air condition unit, smart water devices, smart electrical devices, smart home appliances, home appliances with embedded sensors, and/or smart protection devices. Examples of sensor data may include vehicle telematics data, vehicle ownership, vehicle mileage, vehicle condition including conditions of vehicle parts (e.g., windows, tires, engine, body, etc.), changes in vehicle condition, any sensor data associated with the vehicle 202, home ownership, home condition including conditions of home parts (e.g., bedrooms, kitchen, family rooms, dining rooms, garage, backyard, front yard, etc.), auxiliary features associated with the home (e.g., utilities, water, electricity), changes in home condition, any sensor data associated with the home 210, and/or any combination thereof. It should be understood that other computing devices including one or more sensors, and other sensor data may be contemplated.

At step 903, the system may determine a user situation. For example, the user situation may comprise a driving situation that the vehicle 202 is in during a particular trip. The user may also be referred to as a driver when determining a driving situation. In another example, the user situation may be a home situation indicating a condition of the home 210 for a period of time (e.g., accidents, repairs, number of insurance claims on the home 210). In another example, the user situation may comprise one or more of the driving situation and the home situation. The system may select one or more of factors for determining the user situation. Example factors include weather conditions (e.g., whether it is sunny, cloudy, rainy, etc.) at the vehicle's current location (or in proximity, e.g., within a mile, five miles, etc., of the vehicle), road conditions (e.g., slippery, road work in progress, etc.) the vehicle 202 may encounter, traffic conditions (e.g., heavy, medium, light, etc.) at the vehicle's current location, type of roads (e.g., highways, one way street, street with medium, residential street, etc.) the vehicle 202 is travelling on, conditions inside a vehicle 202 (e.g., noisy, distractions, etc.), conditions outside of the vehicle 202 but in the vehicle's proximity (e.g., towing a boat or trailer, tailgating, etc.), conditions of the vehicle 202 itself (e.g., needs maintenance), conditions of the driver (e.g., whether the driver sleepy, intoxicated, etc.) which may be captured using a camera or other sensor (e.g., breathalyzer), choices a driver makes (e.g., whether to allow text messages or phone calls), driving behavior (e.g., hard braking events, speeding, hard acceleration, hard turning, etc.), number of passengers in the vehicle 202, accident history at the current location (e.g., the driver's accident history, general public's accident history, or accident history of an entity's customers such as the accident history of an insurance company's customers), insurance company claims associated with the current location (e.g., number of insurance claims made for accidents occurring at the current location, damage claimed in insurance claims at the current location), traffic lane (e.g., left lane, middle lane, right lane, etc.), and time of day (e.g., 8am or between 3pm and 5pm).

Further, example factors include conditions or environmental conditions inside the home 210 or in proximity to the home 210. Example conditions may include materials used to build the home 210, types of appliances, age of appliances, age of home, and/or other factors related to the home. In some embodiments, temperature, gas, or air (e.g., carbon monoxide) measurements may be conducted to determine conditions in or in proximity to the home 210. Example factors may include risk factors or profiles that indicate a risk of danger event inside or in proximity to the home 210. Example risk factors may include previous amount of losses (such as a number of times the user has filed a lost claim and the amount of funds receive to repair or replace the loss from, for example, an insurance provider, assets with associated with risk information (such as age of roofing on a property owned by the user, behavioral risk tendencies of the user such as time periods the user has left the home 210 while electronic items or appliances are left unattended), hazards detected in or in proximity to the home 210 such as unattended children or pets when the user or an adult individual is not near the home 210, and the like. Example danger events may include flooding, forest fires, earthquakes, natural disasters, or other danger events that may cause damage to the home 210. Example factors may include home location relative to areas prone to natural disasters (e.g., flooding, forest fires, etc.), or areas of high risk of damage to the home 210.

In some embodiments, other factors may also be selected for consideration in determining the deductible or eligibility for the deductible payment plan. For example, the user's age, gender, eyesight, etc. may be selected. In some embodiments, the factors selected may vary. The factors selected may depend on the user or insurance policy. Certain factors may be considered for one user, but not another. The factors selected may also depend on how long a user has been a customer of an insurance company (e.g., how long an insurance policy has been active). Also, the factors selected may depend on what information is available at a time of making the determination. Moreover, factors selected may depend on other factors. For example, if weather conditions are good and/or it is during the daytime, the system might not consider the type of roads.

Once the factors have been selected for the user situation determination analysis, the system may obtain information associated with the selected factors. For example, if the system selects to consider traffic information, the system may poll a third party server 203 to obtain traffic information. Specifically, the system may send the third party server 203 a current location (e.g., GPS coordinates) of the vehicle 202 and receive traffic information (e.g., whether the traffic in the current location is light, medium, heavy, very heavy, etc.) in return. In another example, if the system selects home information, the system may receive home situation information from the one or more sensors 212 associated with the home 210, a home computing device, and/or the mobile computing device 100m.

In some embodiments, the system may convert (or translate) the obtained information for each selected factor into a standard format or score (e.g., value). In some cases, the system may determine a value for each piece of obtained information. For example, the system may convert information that the current traffic is light into a score of “1”, and convert information that the current traffic is heavy into a score of “5.” In another example, the system may convert information associated with a first condition of the home at a first timestamp (e.g., before a danger event occurs) into a score of “1”, and convert information that associated with a second condition of the home at a second timestamp (e.g., after a danger event occurred) into a score of “5.” Also, the system may, for example, set a certain variable (e.g., a Boolean variable) that is designated for factoring in whether it is raining to have a certain value (e.g., a value of “true”) if the obtained weather information indicates that it is indeed raining where the user is driving. Converting or translating the obtained information may assist the system in considering a plurality of different types of information in a single determination of the user situation. The obtained information in its raw form might not be suitable for use in determining the user situation, and thus, it may be necessary to first convert the raw information.

At step 905, the obtained information or converted information may be used in an algorithm for determining (or computing) a safety score (or level of safety, or degree of safety). In some embodiments, different algorithms may be available and the system may choose which algorithm to use. The algorithm may be selected based on at least one characteristic of the user and/or the insurance policy (e.g., home and/or auto) of the user.

Further, at step 905, the determining of the safety score may include selecting weights used by the algorithm to weigh the obtained information or converted information appropriately. A weight may be a coefficient for a variable designated for a particular type of condition. Different conditions may be weighted differently. Conditions may be weighted contrariwise or conversely in other embodiments. For example, weather conditions may be weighted more heavily than traffic conditions, which may be weighted more heavily than a noise level inside the vehicle 202. For example, zero or a low number of insurance claims for the vehicle 202 may be weighted more heavily than a high number of insurance claims or a number of insurance claims above a predetermined threshold for the vehicle 202. For example, home building materials comprising fire resistant materials may be weighted more heavily than building materials that are not fire resistant. In another example, home locations relative to a non-natural disaster area may be weighted more heavily than home locations relative to a natural disaster area. In another example, temperature or air measurements below a threshold (e.g., temperature threshold that indicates a fire, gas measurement that indicates a presence of a gas) may be weighted more heavily than temperature or air measurements above the threshold. In another example, zero or a low number of insurance claims for the home 210 may be weighted more heavily than a high number of insurance claims or a number of insurance claims above a predetermined threshold for the home 210. In another example, a risk profile for the home 210 that comprises one or more factors that are below a threshold may be weighted more heavily than a risk profile for the home 210 that comprises one or more factors that are above a threshold. It should be understood that other conditions corresponding to a vehicle 202 or a home 210 may be complemented.

Using any determined weights and the obtained information (in either its raw or converted form), an algorithm for determining the safety score for the user situation may be executed. In some embodiments, one or more portions of the sensor data received at step 901 may be processed into weighted portions using one or more algorithms, where one or more weighted portions may be weighted more heavily relative to other weighted portions. In other embodiments, one or more weighted portions may be weighted less relative to other weighted portions. The weighted portions may indicate a safety score and/or a degree of safety for portions of the obtained information. For example, a first weighted portion may indicate a number of vehicle accidents below a threshold which indicates a first safety score/degree of safety, and a second weighted portion may indicate a number of insurance claims on the vehicle 202 below a threshold which indicates a second safety score/degree of safety. In the above example, the first weighted portion and the second weighted portion may be considered together for a total safety score for the driving situation.

In another example, a third weighted portion may indicate a number of insurance claims on the home 210 below a threshold which indicates a third safety score/degree of safety, and a fourth weighted portion may indicate a location of the home 210 relative to area comprising a risk above a threshold which indicates a fourth safety score/degree of safety. In the above example, the third weighted portion and the fourth weighted portion may be considered together for a total safety score for the home situation. In some embodiments, the first weighted portion, the second weighted portion, the third weighted portion, and/or the fourth weighted portion may be considered together for a total safety score of the user situation. The user situation may include safety scores from one or both of the driving situation and the home situation. Execution of the algorithm may result in a numeric value that may represent the total safety score for the user situation. In some embodiments, the weighted portions of the obtained information may be added or summed together to represent the total safety score. In some cases, this safety score may be on a scale of 1 to 100, 1 to 5, any numerical scale, any grading scale, or any other scale. It should be understood that other weighted portions that indicate factors, variables, conditions, etc. of the vehicle 202 or the home 210 may be considered in other embodiments without departing from the disclosure.

At step 907, the deductible determination system may determine if the user is eligible for a deductible payment plan. The deductible determination system may use the deductible associated with the user (e.g., policy holder) for determining eligibility for the deductible payment plan. For example, the deductible determination system may use the deductible that was in effect at the time of an event (e.g., auto or home accident, theft, vandalism, natural disaster, etc.). For example, the deductible determination system may use an adjusted deductible based on a real time current driving situation (e.g., real time driving conditions). For example, the deductible determination system may use the deductible that was in effect at the time of initial purchase or signup of a vehicle or a home. For example, the deductible determination system may use a deductible determined from a trial period or a particular number of driving trips before the purchase or signup of the deductible.

At step 907, eligibility for the deductible payment plan may further be based on the safety score determined in step 905. The eligibility for the deductible payment plan may be based on the safety score or degree of safety determined for the user situation. For example, the deductible determination system may determine eligibility for the deductible payment plan if the safety score is above a threshold or below a threshold. In some embodiments, the deductible determination system may determine eligibility for the deductible payment plan based on the sensor data at step 901, and whether the safety score determined at step 905 is above or below a threshold.

For example, the deductible determination system may determine the user is eligible for deductible payment plan if the safety score is above a predetermined numerical threshold associated with high safety (e.g., low number of accidents, no accidents, consistent braking, no mobile device usage during driving, no distracted driving, low number of home repairs/damages, no insurance claims on the home 210, home 210 located away from a natural disaster area or an area comprising a risk above a threshold, etc.). For example, if the safety score exceeds an 80 out of 100, the deductible determination system may determine eligibility whereas as a score of 75 might not trigger the system to determine eligibility of the deductible payment plan. The thresholds described herein may different for different users, different user situations, different driving situations, or different home situations.

Alternatively, the system may determine the user is not eligible for the deductible payment plan (i.e., no at step 907). For example, if the safety score is below a threshold, then the system may not approve the user for the deductible payment plan. For example, if the safety score is below a predetermined threshold indicating low safety, then the system may determine the user is not eligible for the deductible payment plan. In some embodiments, the system may determine the user needs to pay the deductible at the time of an event associated with the vehicle 202 or home 210.

After the system determines the user is eligible for the deductible payment plan (i.e., yes at step 907), at step 909, the user may enroll into the deductible payment plan. The system may present (e.g., graphical user interface, notification, electronic message, etc.) the deductible payment plan to the user for enrollment. The system may offer the deductible payment plan immediately at the time of accident (e.g., vehicle or home), provisionally pending a damage estimation, or after the damage estimation. The system may send an alert or notification to a device (e.g., mobile computing device 100m) connected to the deductible determination system indicating the user is approved for the deductible payment plan. The user may enroll into the deductible payment plan at the time of accident or a time after the accident occurred. The user may enroll into the deductible payment plan using mobile computing device 100m or another device connected in the deductible determination system. The user may make payments over a period of time (e.g., weeks, months, or years) to the deductible payment plan using the mobile computing device 100m or other connected device.

It should be understood that the method of FIG. 10 is an example and that other methods with similar steps are contemplated. In such other methods, additional steps may be included or steps may be omitted. Also, other methods may change the order of any of the steps. For example, the method of FIG. 10 may occur in real-time when one or more events occur at the vehicle 202 or the home 210 over a period of time. For example, at step 905, the system may determine a safety score for one or both of the driving situation and the home situation, where one or both of the driving situation and the home situation may be considered for the user situation. In other embodiments, the user situation may be associated with only the driving situation or only the home situation depending on a user's insurance policy coverage (e.g., auto or home).

Representative features are set out in the following clauses, which stand alone or may be combined, in any combination, with one or more features disclosed in the text and/or drawings of the specification.

Clause 1. A method comprising: receiving, by a computing device, sensor data from one or more sensors associated with a user, the sensor data including user situation information indicating a user situation related to a vehicle traveling along a route or a condition of a home for a predetermined period of time, the user situation information including data detected by the one or more sensors; selecting, based on at least one characteristic of the user and on at least a portion of the user situation information, one of a plurality of algorithms, wherein each algorithm of the plurality of algorithms is configured to process the sensor data; determining, based on at least the portion of the user situation information and using the selected one of the plurality of algorithms, a degree of safety of the user situation; obtaining a deductible of an insurance policy for the vehicle or the home; determining, based on the sensor data and the degree of safety of the user situation, an eligibility for a deductible payment plan for paying the deductible over a period of time; and presenting the deductible payment plan to the user for enrollment, responsive to the determination that the user is eligible for the deductible payment plan.

Clause 2. The method of Clause 1, wherein the one or more sensors are associated with a mobile computing device, a vehicle computing device associated with the vehicle, or a home computing device associated with the home.

Clause 3. The method of Clause 1 to Clause 2, wherein the user situation information comprises at least one of: driving behavior information regarding a speed, an acceleration, or a deceleration of the vehicle; driver status information regarding a condition of the user of the vehicle; and vehicle condition information regarding a condition inside or in proximity to the vehicle.

Clause 4. The method of Clause 1 to Clause 3, wherein the user situation information comprises at least one of: risk information indicative of a risk of a danger event inside or in proximity to the home; and environment condition information indicating an environmental condition inside the home or in proximity to the home.

Clause 5. The method of Clause 1 to Clause 4, wherein the determining the deductible payment plan based on the degree of safety of the user situation comprises using data associated with past accidents or past insurance claims.

Clause 6. The method of Clause 1 to Clause 5, wherein the determining the deductible payment plan using the data associated with past accidents or past insurance claims comprises increasing eligibility for the deductible payment plan when a number of past accidents associated with the vehicle is below a first threshold or decreasing eligibility for the deductible payment plan when the number of past accidents associated with the vehicle is above a second threshold.

Clause 7. The method of Clause 1 to Clause 6, wherein the determining the deductible payment plan using the data associated with past accidents or past insurance claims comprises increasing eligibility for the deductible payment plan when a risk of a danger event inside or in proximity to the home is below a first threshold or decreasing eligibility for the deductible payment plan when the risk of the danger event is above a second threshold.

Clause 8. The method of Clause 1 to Clause 7, wherein the determining the degree of safety using the selected one of the plurality of algorithms includes identifying one or more weights to be applied to one or more variables in the selected one of the plurality of algorithms.

Clause 9. A system comprising: a non-transitory computer-readable medium storing a set of processor-executable instructions; and one or more processors configured to execute the set of processor-executable instructions, wherein executing the set of processor-executable instructions causes the one or more processors to: receive, by a computing device, sensor data from one or more sensors associated with a user, the sensor data including user situation information indicating a user situation related to a vehicle traveling along a route or a condition of a home for a predetermined period of time, the user situation information including data detected by the one or more sensors; select, based on at least one characteristic of the user and on at least a portion of the user situation information, one of a plurality of algorithms, wherein each algorithm of the plurality of algorithms is configured to process the sensor data; determine, based on at least the portion of the user situation information and using the selected one of the plurality of algorithms, a degree of safety of the user situation; obtain a deductible of an insurance policy for the vehicle or the home; determine, based on the sensor data and the degree of safety of the user situation, an eligibility for a deductible payment plan for paying the deductible over a period of time; and present the deductible payment plan to the user for enrollment, responsive to the determination that the user is eligible for the deductible payment plan.

Clause 10. The system of Clause 9, wherein the one or more sensors are associated with a mobile computing device, a vehicle computing device associated with the vehicle, or a home computing device associated with the home.

Clause 11. The system of Clause 9 to Clause 10, wherein the user situation information comprises at least one of: driving behavior information regarding a speed, an acceleration, or a deceleration of the vehicle; driver status information regarding a condition of the user of the vehicle; and vehicle condition information regarding a condition inside or in proximity to the vehicle.

Clause 12. The system of Clause 9 to Clause 11, wherein the user situation information comprises at least one of: risk information indicative of a risk of a danger event inside or in proximity to the home; and environment condition information indicating an environmental condition inside the home or in proximity to the home.

Clause 13. The system of Clause 9 to Clause 12, wherein the determining the deductible payment plan based on the degree of safety of the user situation comprises using data associated with past accidents or past insurance claims.

Clause 14. The system of Clause 9 to Clause 13, wherein the determining the deductible payment plan using the data associated with past accidents or past insurance claims comprises increasing eligibility for the deductible payment plan when a number of past accidents associated with the vehicle is below a first threshold or decreasing eligibility for the deductible payment plan when the number of past accidents associated with the vehicle is above a second threshold.

Clause 15. The system of Clause 9 to Clause 14, wherein the determining the deductible payment plan using the data associated with past accidents or past insurance claims comprises increasing eligibility for the deductible payment plan when a risk of a danger event inside or in proximity to the home is below a first threshold or decreasing eligibility for the deductible payment plan when the risk of the danger event is above a second threshold.

Clause 16. The system of Clause 9 to Clause 15, wherein the determining the degree of safety using the selected one of the plurality of algorithms includes identifying one or more weights to be applied to one or more variables in the selected one of the plurality of algorithms.

Clause 17. A non-transitory computer readable medium storing computer-executable instructions that, when executed, cause at least one processor to: receive, by a computing device, sensor data from one or more sensors associated with a user, the sensor data including user situation information indicating a user situation related to a vehicle traveling along a route or a condition of a home for a predetermined period of time, the user situation information including data detected by the one or more sensors; select, based on at least one characteristic of the user and on at least a portion of the user situation information, one of a plurality of algorithms, wherein each algorithm of the plurality of algorithms is configured to process the sensor data; determine, based on at least the portion of the user situation information and using the selected one of the plurality of algorithms, a degree of safety of the user situation; obtain a deductible of an insurance policy for the vehicle or the home; determine, based on the sensor data and the degree of safety of the user situation, an eligibility for a deductible payment plan for paying the deductible over a period of time; and present the deductible payment plan to the user for enrollment, responsive to the determination that the user is eligible for the deductible payment plan.

Clause 18. The non-transitory computer-readable storage medium of Clause 17, wherein the one or more sensors are associated with a mobile computing device, a vehicle computing device associated with the vehicle, or a home computing device associated with the home.

Clause 19. The non-transitory computer-readable storage medium of Clause 17 to Clause 18, wherein the user situation information comprises at least one of: driving behavior information regarding a speed, an acceleration, or a deceleration of the vehicle; driver status information regarding a condition of the user of the vehicle; and vehicle condition information regarding a condition inside or in proximity to the vehicle.

Clause 20. The non-transitory computer-readable storage medium of Clause 17 to Clause 19, wherein the user situation information comprises at least one of: risk information indicative of a risk of a danger event inside or in proximity to the home; and environment condition information indicating an environmental condition inside the home or in proximity to the home.

Aspects of the invention have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention. For example, step 301 might not be performed each time the process is performed.

1. A method comprising:
receiving, by a computing device, sensor data from one or more sensors associated with a user, the sensor data including user situation information indicating a user situation related to a vehicle traveling along a route or a condition of a home for a predetermined period of time, the user situation information including data detected by the one or more sensors;
selecting, based on at least one characteristic of the user and on at least a portion of the user situation information, one of a plurality of algorithms, wherein each algorithm of the plurality of algorithms is configured to process the sensor data;
determining, based on at least the portion of the user situation information and using the selected one of the plurality of algorithms, a degree of safety of the user situation;
obtaining a deductible of an insurance policy for the vehicle or the home;
determining, based on the sensor data and the degree of safety of the user situation, an eligibility for a deductible payment plan for paying the deductible over a period of time; and
presenting the deductible payment plan to the user for enrollment, responsive to the determination that the user is eligible for the deductible payment plan.

2. The method of claim 1, wherein the one or more sensors are associated with a mobile computing device, a vehicle computing device associated with the vehicle, or a home computing device associated with the home.

3. The method of claim 1, wherein the user situation information comprises at least one of:
driving behavior information regarding a speed, an acceleration, or a deceleration of the vehicle;
driver status information regarding a condition of the user of the vehicle; and
vehicle condition information regarding a condition inside or in proximity to the vehicle.

4. The method of claim 1, wherein the user situation information comprises at least one of:
risk information indicative of a risk of a danger event inside or in proximity to the home; and
environment condition information indicating an environmental condition inside the home or in proximity to the home.

5. The method of claim 1, wherein the determining the deductible payment plan based on the degree of safety of the user situation comprises using data associated with past accidents or past insurance claims.

6. The method of claim 5, wherein the determining the deductible payment plan using the data associated with past accidents or past insurance claims comprises increasing eligibility for the deductible payment plan when a number of past accidents associated with the vehicle is below a first threshold or decreasing eligibility for the deductible payment plan when the number of past accidents associated with the vehicle is above a second threshold.

7. The method of claim 5, wherein the determining the deductible payment plan using the data associated with past accidents or past insurance claims comprises increasing eligibility for the deductible payment plan when a risk of a danger event inside or in proximity to the home is below a first threshold or decreasing eligibility for the deductible payment plan when the risk of the danger event is above a second threshold.

8. The method of claim 1, wherein the determining the degree of safety using the selected one of the plurality of algorithms includes identifying one or more weights to be applied to one or more variables in the selected one of the plurality of algorithms.

9. A system comprising:
a non-transitory computer-readable medium storing a set of processor-executable instructions; and
one or more processors configured to execute the set of processor-executable instructions, wherein executing the set of processor-executable instructions causes the one or more processors to:
receive, by a computing device, sensor data from one or more sensors associated with a user, the sensor data including user situation information indicating a user situation related to a vehicle traveling along a route or a condition of a home for a predetermined period of time, the user situation information including data detected by the one or more sensors;
select, based on at least one characteristic of the user and on at least a portion of the user situation information, one of a plurality of algorithms, wherein each algorithm of the plurality of algorithms is configured to process the sensor data;
determine, based on at least the portion of the user situation information and using the selected one of the plurality of algorithms, a degree of safety of the user situation;
obtain a deductible of an insurance policy for the vehicle or the home;
determine, based on the sensor data and the degree of safety of the user situation, an eligibility for a deductible payment plan for paying the deductible over a period of time; and
present the deductible payment plan to the user for enrollment, responsive to the determination that the user is eligible for the deductible payment plan.

10. The system of claim 9, wherein the one or more sensors are associated with a mobile computing device, a vehicle computing device associated with the vehicle, or a home computing device associated with the home.

11. The system of claim 9, wherein the user situation information comprises at least one of:
driving behavior information regarding a speed, an acceleration, or a deceleration of the vehicle;
driver status information regarding a condition of the user of the vehicle; and
vehicle condition information regarding a condition inside or in proximity to the vehicle.

12. The system of claim 9, wherein the user situation information comprises at least one of:
risk information indicative of a risk of a danger event inside or in proximity to the home; and
environment condition information indicating an environmental condition inside the home or in proximity to the home.

13. The system of claim 9, wherein the determining the deductible payment plan based on the degree of safety of the user situation comprises using data associated with past accidents or past insurance claims.

14. The system of claim 13, wherein the determining the deductible payment plan using the data associated with past accidents or past insurance claims comprises increasing eligibility for the deductible payment plan when a number of past accidents associated with the vehicle is below a first threshold or decreasing eligibility for the deductible payment plan when the number of past accidents associated with the vehicle is above a second threshold.

15. The system of claim 13, wherein the determining the deductible payment plan using the data associated with past accidents or past insurance claims comprises increasing eligibility for the deductible payment plan when a risk of a danger event inside or in proximity to the home is below a first threshold or decreasing eligibility for the deductible payment plan when the risk of the danger event is above a second threshold.

16. The system of claim 9, wherein the determining the degree of safety using the selected one of the plurality of algorithms includes identifying one or more weights to be applied to one or more variables in the selected one of the plurality of algorithms.

17. A non-transitory computer readable medium storing computer-executable instructions that, when executed, cause at least one processor to:
receive, by a computing device, sensor data from one or more sensors associated with a user, the sensor data including user situation information indicating a user situation related to a vehicle traveling along a route or a condition of a home for a predetermined period of time, the user situation information including data detected by the one or more sensors;
select, based on at least one characteristic of the user and on at least a portion of the user situation information, one of a plurality of algorithms, wherein each algorithm of the plurality of algorithms is configured to process the sensor data;
determine, based on at least the portion of the user situation information and using the selected one of the plurality of algorithms, a degree of safety of the user situation;
obtain a deductible of an insurance policy for the vehicle or the home;
determine, based on the sensor data and the degree of safety of the user situation, an eligibility for a deductible payment plan for paying the deductible over a period of time; and
present the deductible payment plan to the user for enrollment, responsive to the determination that the user is eligible for the deductible payment plan.

18. The non-transitory computer-readable storage medium of claim 17, wherein the one or more sensors are associated with a mobile computing device, a vehicle computing device associated with the vehicle, or a home computing device associated with the home.

19. The non-transitory computer-readable storage medium of claim 17, wherein the user situation information comprises at least one of:
driving behavior information regarding a speed, an acceleration, or a deceleration of the vehicle;
driver status information regarding a condition of the user of the vehicle; and
vehicle condition information regarding a condition inside or in proximity to the vehicle.

20. The non-transitory computer-readable storage medium of claim 17, wherein the user situation information comprises at least one of:
risk information indicative of a risk of a danger event inside or in proximity to the home; and
environment condition information indicating an environmental condition inside the home or in proximity to the home.
